(19) United States
(12) Patent Application Publication
(10) Pub. No.: US 2024/0321034 A1
(43) Pub. Date: Sep. 26, 2024

(54) AUGMENTED REALITY ACTIVATED DISPENSING MACHINE

(71) Applicant: Snap Inc., Santa Monica, CA (US)

(72) Inventor: Adrian Bradford, Los Angeles, CA (US)

(21) Appl. No.: 18/617,091

(22) Filed: Mar. 26, 2024

Related U.S. Application Data
(60) Provisional application No. 63/454,810, filed on Mar. 27, 2023.
(60) Provisional application No. 63/454,712, filed on Mar. 26, 2023.

(51) Int. Cl. G07F 11/62; G06Q 20/18

(52) U.S. Cl. CPC G07F 11/62; G06Q 20/18

(57) ABSTRACT

Systems, methods, and computer readable media for augmented reality (AR) activated dispensing machines are disclosed. Example methods include a dispensing machine that is configured to access a captured image, process the image to generate an avatar of a user, present an image of the avatar with an indication of a vending item on the display of the system, determine the user performed a gesture to select the vending item, and dispense the selected vending item. Additionally, the dispensing machine is configured to provide virtual musical instruments to the user and record a music video. The dispensing machine is configured to communicate with a user device and send codes for vending items and AR graphics to be displayed to the user.

### PRIORITY CLAIM

This application claims the benefit of priority under 35 USC 119(e) to U.S. Provisional Patent Application Ser. No. 63/454,712, filed Mar. 26, 2023, and to U.S. Provisional Patent Application Ser. No. 63/454,810, filed Mar. 27, 2023 both of which are incorporated herein by reference in their entirety.

### TECHNICAL FIELD

Examples of the present disclosure relate generally to users interacting with dispensing machines with augmented reality (AR), mixed reality (MR), or virtual reality (VR). More particularly, but not by way of limitation, examples of the present disclosure relate to a user interacting with a dispensing machine that incorporates an AR, MR, or VR image of the user and images of vending items on a display of the dispensing machine.

### BACKGROUND

Users increasingly want dispensing machines to operate in a more user-friendly manner with more functions. However, automated machines are often limited in the user interface experiences the automated machine can provide to a user.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1 is a diagrammatic representation of a networked environment in which the present disclosure may be deployed, according to some examples.

FIG. 2 is a diagrammatic representation of a messaging system that has both client-side and server-side functionality, according to some examples.

FIG. 3 is a diagrammatic representation of a data structure as maintained in a database, according to some examples.

FIG. 4 is a diagrammatic representation of a message, according to some examples.

FIG. 5 illustrates a system of a head-wearable apparatus, according to some examples.

FIG. 6 is a diagrammatic representation of a machine in the form of a computer system within which a set of instructions may be executed to cause the machine to perform any one or more of the methodologies discussed herein, according to some examples.

FIG. 7 is a block diagram of a software architecture within which examples may be implemented.

FIG. 8 is a perspective view of a head-wearable apparatus in the form of glasses, in accordance with some examples.

FIG. 9 is a schematic diagram of a system for a dispensing machine, in accordance with some examples.

FIG. 10 is a schematic diagram of a system for a dispensing machine, in accordance with some examples.

FIG. 11 is a schematic diagram of a system for a dispensing machine, in accordance with some examples.

FIG. 12 is a schematic diagram of a system for a dispensing machine, in accordance with some examples.

FIG. 13 is a schematic diagram of a system for a dispensing machine, in accordance with some examples.

FIG. 14 is a schematic diagram of a system for a dispensing machine, in accordance with some examples.

FIG. 15 is a schematic diagram of a system for a dispensing machine, in accordance with some examples.

FIG. 16 is a schematic diagram of a system for a dispensing machine, in accordance with some examples.

FIG. 17 is a schematic diagram of a system for a dispensing machine, in accordance with some examples.

FIG. 18 is a schematic diagram of a system for a dispensing machine, in accordance with some examples.

FIG. 19 is a schematic diagram of a system for a dispensing machine, in accordance with some examples.

FIG. 20 is a schematic diagram of a system for a dispensing machine, in accordance with some examples.

FIG. 21 is a schematic diagram of a system for a dispensing machine, in accordance with some examples.

FIG. 22 is a schematic diagram of a system for a dispensing machine, in accordance with some examples.

FIG. 23 is a schematic diagram of a system for a dispensing machine, in accordance with some examples.

FIG. 24 is a flow diagram of a method for augmented reality activated dispensing machines, in accordance with some examples.

### DETAILED DESCRIPTION

The term AR wearable device is used as an illustrative device; however, one skilled in the art will recognize that the methods, systems, and computer readable medium disclosed herein are applicable to other wearable devices such as mixed reality (MR) wearable devices and virtual reality (VR) wearable devices.

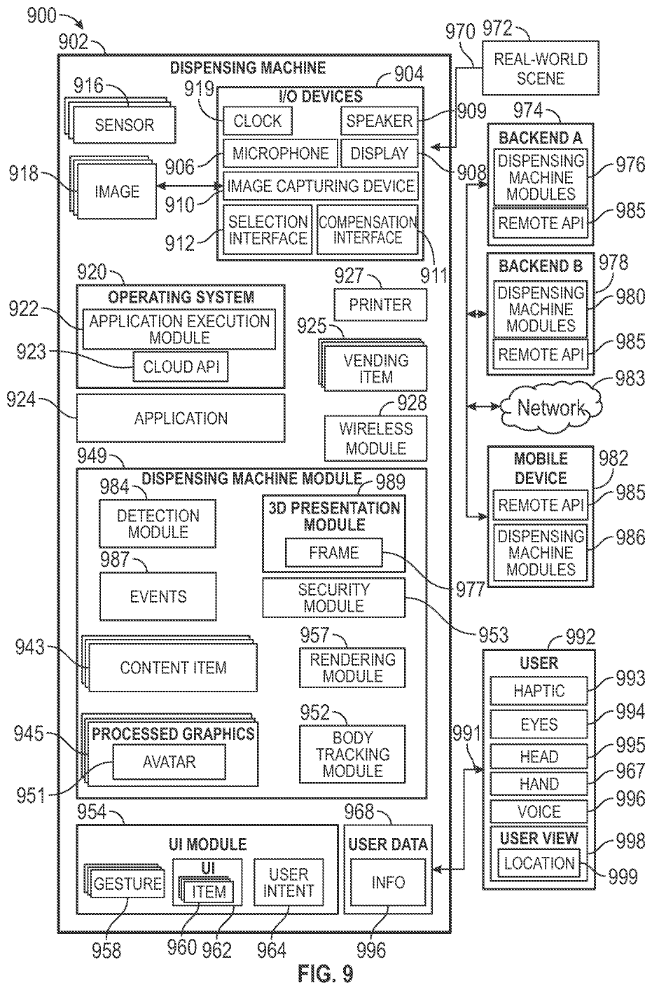

Referring to FIG. 9, often dispensing machines 902 or vending machines have limited user interfaces that make it difficult to provide some vending items 925. Users 992 often will not spend large amounts of time trying to determine the proper vending item 925 or will not be able to decide if the vending item 925 is appropriate for them.

The dispending machine 902 addresses these technical challenges by providing a display and AR or 3D graphics for the user 992 to view the vending items 925. The dispensing machine 902 includes an image capturing device 910 that determines the location 999 of the user 992 and may display an avatar 951 of or for the user 992. The dispensing machine 902 generates graphics to display that appear to be 3D for the user 992 based on a location 999 of the user 992 relative to the display 908 of the dispensing machine 902. The dispensing machine 902 provides virtual try-on of clothing items dispensed by the dispensing machine 902. The dispensing machine 902 may provide vending items 925 that include tickets and so forth. The tickets and so forth may be provided with electronic codes that may be physical printed by the dispensing machine 902.

The user 992 may select among many different vending items 925 using gestures 958, which enable the user 992 to interact with the dispensing machine 902 without touching the dispensing machine 902. Moreover, the dispensing machine 902 provides engaging activities for the user 992 to promote product awareness and brand awareness. For example, the dispensing machine 902 provides an application 924 that enables the user 992 to generate music videos by providing gesture 958 controlled musical instruments on the display 908.

### Networked Computing Environment

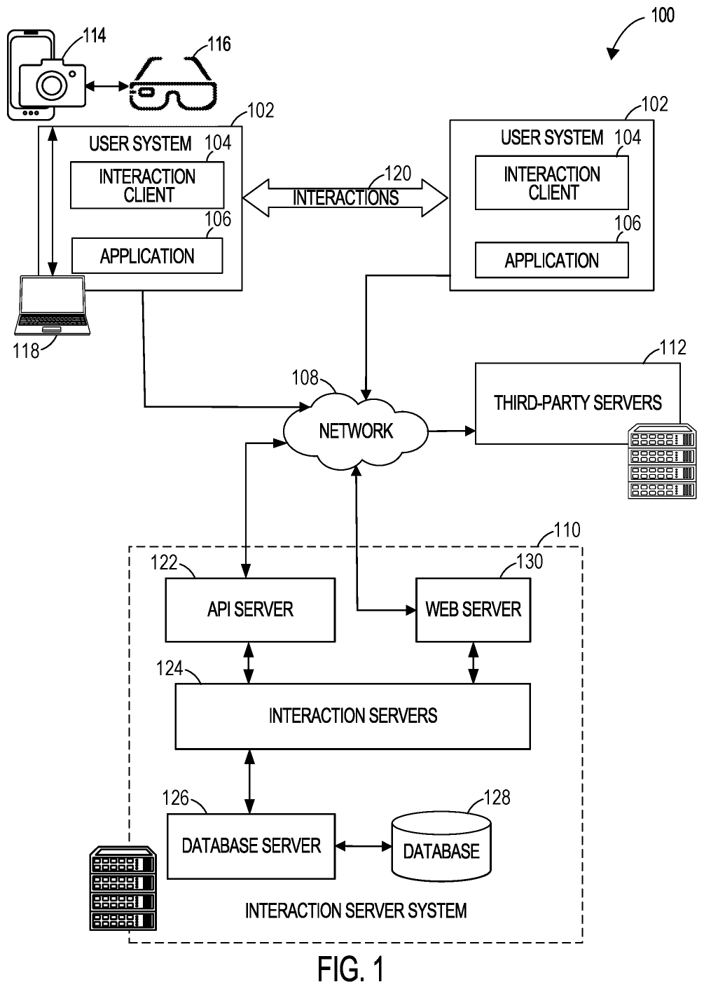

FIG. 1 is a block diagram showing an example interaction system 100 for facilitating interactions (e.g., exchanging text messages, conducting text audio and video calls, or playing games) over a network. The interaction system 100 includes multiple user systems 102, each of which hosts multiple applications, including an interaction client 104 and other applications 106. Each interaction client 104 is communicatively coupled, via one or more communication networks including a network 108 (e.g., the Internet), to other instances of the interaction client 104 (e.g., hosted on respective other user systems 102), an interaction server system 110 and third-party servers 112). An interaction client 104 can also communicate with locally hosted applications 106 using Applications Program Interfaces (APIs).

Each user system 102 may include multiple user devices, such as a computing device 114, head-wearable apparatus 116, and a computer client device 118 that are communicatively connected to exchange data and messages.

An interaction client 104 interacts with other interaction clients 104 and with the interaction server system 110 via the network 108. The data exchanged between the interaction clients 104 (e.g., interactions 120) and between the interaction clients 104 and the interaction server system 110 includes functions (e.g., commands to invoke functions) and payload data (e.g., text, audio, video, or other multimedia data).

The interaction server system 110 provides server-side functionality via the network 108 to the interaction clients 104. While certain functions of the interaction system 100 are described herein as being performed by either an interaction client 104 or by the interaction server system 110, the location of certain functionality either within the interaction client 104 or the interaction server system 110 may be a design choice. For example, it may be technically preferable to initially deploy particular technology and functionality within the interaction server system 110 but to later migrate this technology and functionality to the interaction client 104 where a user system 102 has sufficient processing capacity.

The interaction server system 110 supports various services and operations that are provided to the interaction clients 104. Such operations include transmitting data to, receiving data from, and processing data generated by the interaction clients 104. This data may include message content, client device information, geolocation information, media augmentation and overlays, message content persistence conditions, entity relationship information, and live event information. Data exchanges within the interaction system 100 are invoked and controlled through functions available via user interfaces (UIs) of the interaction clients 104.

Turning now specifically to the interaction server system 110, an Application Program Interface (API) server 122 is coupled to and provides programmatic interfaces to interaction servers 124, making the functions of the interaction servers 124 accessible to interaction clients 104, other applications 106 and third-party server 112. The interaction servers 124 are communicatively coupled to a database server 126, facilitating access to a database 128 that stores data associated with interactions processed by the interaction servers 124. Similarly, a web server 130 is coupled to the interaction servers 124 and provides web-based interfaces to the interaction servers 124. To this end, the web server 130 processes incoming network requests over the Hypertext Transfer Protocol (HTTP) and several other related protocols.

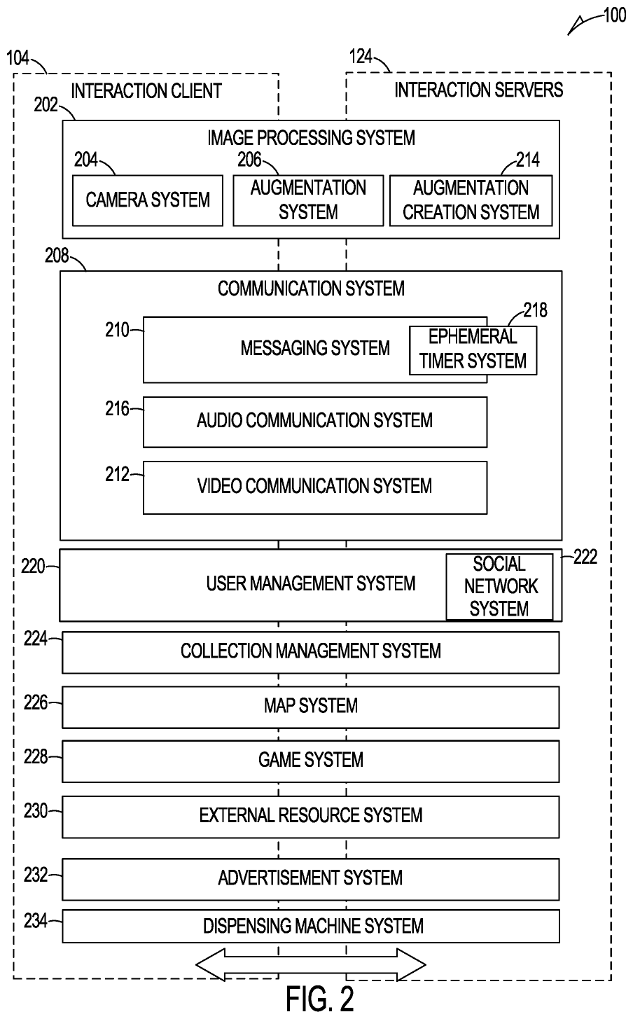

The Application Program Interface (API) server 122 receives and transmits interaction data (e.g., commands and message payloads) between the interaction servers 124 and the user systems 102 (and, for example, interaction clients 104 and other application 106) and the third-party server 112. Specifically, the Application Program Interface (API) server 122 provides a set of interfaces (e.g., routines and protocols) that can be called or queried by the interaction client 104 and other applications 106 to invoke functionality of the interaction servers 124. The Application Program Interface (API) server 122 exposes various functions supported by the interaction servers 124, including account registration; login functionality; the sending of interaction data, via the interaction servers 124, from a particular interaction client 104 to another interaction client 104; the communication of media files (e.g., images or video) from an interaction client 104 to the interaction servers 124; the settings of a collection of media data (e.g., a story); the retrieval of a list of friends of a user of a user system 102; the retrieval of messages and content; the addition and deletion of entities (e.g., friends) to an entity relationship graph (e.g., the entity graph 310); the location of friends within an entity relationship graph; and opening an application event (e.g., relating to the interaction client 104). The interaction servers 124 host multiple systems and subsystems, described below with reference to FIG. 2.

### Linked Applications

Returning to the interaction client 104, features and functions of an external resource (e.g., a linked application 106 or applet) are made available to a user via an interface of the interaction client 104. In this context, “external” refers to the fact that the application 106 or applet is external to the interaction client 104. The external resource is often provided by a third party but may also be provided by the creator or provider of the interaction client 104. The interaction client 104 receives a user selection of an option to launch or access features of such an external resource. The external resource may be the application 106 installed on the user system 102 (e.g., a “native app”), or a small-scale version of the application (e.g., an “applet”) that is hosted on the user system 102 or remote of the user system 102 (e.g., on third-party servers 112). The small-scale version of the application includes a subset of features and functions of the application (e.g., the full-scale, native version of the application) and is implemented using a markup-language document. In some examples, the small-scale version of the application (e.g., an “applet”) is a web-based, markup-language version of the application and is embedded in the interaction client 104. In addition to using markup-language documents (e.g., a .*ml file), an applet may incorporate a scripting language (e.g., a .*js file or a .json file) and a style sheet (e.g., a .*ss file).

In response to receiving a user selection of the option to launch or access features of the external resource, the interaction client 104 determines whether the selected external resource is a web-based external resource or a locally-installed application 106. In some cases, applications 106 that are locally installed on the user system 102 can be launched independently of and separately from the interaction client 104, such as by selecting an icon corresponding to the application 106 on a home screen of the user system 102. Small-scale versions of such applications can be launched or accessed via the interaction client 104 and, in some examples, no or limited portions of the small-scale application can be accessed outside of the interaction client 104. The small-scale application can be launched by the interaction client 104 receiving, from a third-party server 112 for example, a markup-language document associated with the small-scale application and processing such a document.

In response to determining that the external resource is a locally installed application 106, the interaction client 104 instructs the user system 102 to launch the external resource by executing locally stored code corresponding to the external resource. In response to determining that the external resource is a web-based resource, the interaction client 104 communicates with the third-party servers 112 (for example) to obtain a markup-language document corresponding to the selected external resource. The interaction client 104 then processes the obtained markup-language document to present the web-based external resource within a user interface of the interaction client 104.

The interaction client 104 can notify a user of the user system 102, or other users related to such a user (e.g., “friends”), of activity taking place in one or more external resources. For example, the interaction client 104 can provide participants in a conversation (e.g., a chat session) in the interaction client 104 with notifications relating to the current or recent use of an external resource by one or more members of a group of users. One or more users can be invited to join in an active external resource or to launch a recently used but currently inactive (in the group of friends) external resource. The external resource can provide participants in a conversation, each using respective interaction clients 104, with the ability to share an item, status, state, or location in an external resource in a chat session with one or more members of a group of users. The shared item may be an interactive chat card with which members of the chat can interact, for example, to launch the corresponding external resource, view specific information within the external resource, or take the member of the chat to a specific location or state within the external resource. Within a given external resource, response messages can be sent to users on the interaction client 104. The external resource can selectively include different media items in the responses, based on a current context of the external resource.

The interaction client 104 can present a list of the available external resources (e.g., applications 106 or applets) to a user to launch or access a given external resource. This list can be presented in a context-sensitive menu. For example, the icons representing different ones of the application 106 (or applets) can vary based on how the menu is launched by the user (e.g., from a conversation interface or from a non-conversation interface).

### System Architecture

FIG. 2 is a block diagram illustrating further details regarding the interaction system 100, according to some examples. Specifically, the interaction system 100 is shown to comprise the interaction client 104 and the interaction servers 124. The interaction system 100 embodies multiple subsystems, which are supported on the client-side by the interaction client 104 and on the server-side by the interaction servers 124. In some examples, these subsystems are implemented as microservices. A microservice subsystem (e.g., a microservice application) may have components that enable it to operate independently and communicate with other services. Example components of microservice subsystem may include:
Function logic: The function logic implements the functionality of the microservice subsystem, representing a specific capability or function that the microservice provides.
API interface: Microservices may communicate with each other components through well-defined APIs or interfaces, using lightweight protocols such as REST or messaging. The API interface defines the inputs and outputs of the microservice subsystem and how it interacts with other microservice subsystems of the interaction system 100.
Data storage: A microservice subsystem may be responsible for its own data storage, which may be in the form of a database, cache, or other storage mechanism (e.g., using the database server 126 and database 128). This enables a microservice subsystem to operate independently of other microservices of the interaction system 100.
Service discovery: Microservice subsystems may find and communicate with other microservice subsystems of the interaction system 100. Service discovery mechanisms enable microservice subsystems to locate and communicate with other microservice subsystems in a scalable and efficient way.
Monitoring and logging: Microservice subsystems may need to be monitored and logged in order to ensure availability and performance. Monitoring and logging mechanisms enable the tracking of health and performance of a microservice subsystem.

In some examples, the interaction system 100 may employ a monolithic architecture, a service-oriented architecture (SOA), a function-as-a-service (FaaS) architecture, or a modular architecture: Example subsystems are discussed below.

An image processing system 202 provides various functions that enable a user to capture and augment (e.g., annotate or otherwise modify or edit) media content associated with a message.

A camera system 204 includes control software (e.g., in a camera application) that interacts with and controls hardware camera hardware (e.g., directly or via operating system controls) of the user system 102 to modify and augment real-time images captured and displayed via the interaction client 104.

The augmentation system 206 provides functions related to the generation and publishing of augmentations (e.g., media overlays) for images captured in real-time by cameras of the user system 102 or retrieved from memory of the user system 102. For example, the augmentation system 206 operatively selects, presents, and displays media overlays (e.g., an image filter or an image lens) to the interaction client 104 for the augmentation of real-time images received via the camera system 204 or stored images retrieved from memory 502 of a user system 102. These augmentations are selected by the augmentation system 206 and presented to a user of an interaction client 104, based on a number of inputs and data, such as for example:
Geolocation of the user system 102; and
Entity relationship information of the user of the user system 102.

An augmentation may include audio and visual content and visual effects. Examples of audio and visual content include pictures, texts, logos, animations, and sound effects. An example of a visual effect includes color overlaying. The audio and visual content or the visual effects can be applied to a media content item (e.g., a photo or video) at user system 102 for communication in a message, or applied to video content, such as a video content stream or feed transmitted from an interaction client 104. As such, the image processing system 202 may interact with, and support, the various subsystems of the communication system 208, such as the messaging system 210 and the video communication system 212.

A media overlay may include text or image data that can be overlaid on top of a photograph taken by the user system 102 or a video stream produced by the user system 102. In some examples, the media overlay may be a location overlay (e.g., Venice beach), a name of a live event, or a name of a merchant overlay (e.g., Beach Coffee House). In further examples, the image processing system 202 uses the geolocation of the user system 102 to identify a media overlay that includes the name of a merchant at the geolocation of the user system 102. The media overlay may include other indicia associated with the merchant. The media overlays may be stored in the databases 128 and accessed through the database server 126.

The image processing system 202 provides a user-based publication platform that enables users to select a geolocation on a map and upload content associated with the selected geolocation. The user may also specify circumstances under which a particular media overlay should be offered to other users. The image processing system 202 generates a media overlay that includes the uploaded content and associates the uploaded content with the selected geolocation.

The augmentation creation system 214 supports augmented reality developer platforms and includes an application for content creators (e.g., artists and developers) to create and publish augmentations (e.g., augmented reality experiences) of the interaction client 104. The augmentation creation system 214 provides a library of built-in features and tools to content creators including, for example custom shaders, tracking technology, and templates.

In some examples, the augmentation creation system 214 provides a merchant-based publication platform that enables merchants to select a particular augmentation associated with a geolocation via a bidding process. For example, the augmentation creation system 214 associates a media overlay of the highest bidding merchant with a corresponding geolocation for a predefined amount of time.

A communication system 208 is responsible for enabling and processing multiple forms of communication and interaction within the interaction system 100 and includes a messaging system 210, an audio communication system 216, and a video communication system 212. The messaging system 210 is responsible for enforcing the temporary or time-limited access to content by the interaction clients 104. The messaging system 210 incorporates multiple timers (e.g., within an ephemeral timer system) that, based on duration and display parameters associated with a message or collection of messages (e.g., a story), selectively enable access (e.g., for presentation and display) to messages and associated content via the interaction client 104. The audio communication system 216 enables and supports audio communications (e.g., real-time audio chat) between multiple interaction clients 104. Similarly, the video communication system 212 enables and supports video communications (e.g., real-time video chat) between multiple interaction clients 104.

A user management system 218 is operationally responsible for the management of user data and profiles, and maintains entity information (e.g., stored in entity tables 308, entity graphs 310 and profile data 302) regarding users and relationships between users of the interaction system 100.

A collection management system 220 is operationally responsible for managing sets or collections of media (e.g., collections of text, image video, and audio data). A collection of content (e.g., messages, including images, video, text, and audio) may be organized into an “event gallery” or an “event story.” Such a collection may be made available for a specified time period, such as the duration of an event to which the content relates. For example, content relating to a music concert may be made available as a “story” for the duration of that music concert. The collection management system 220 may also be responsible for publishing an icon that provides notification of a particular collection to the user interface of the interaction client 104. The collection management system 220 includes a curation function that allows a collection manager to manage and curate a particular collection of content. For example, the curation interface enables an event organizer to curate a collection of content relating to a specific event (e.g., delete inappropriate content or redundant messages). Additionally, the collection management system 220 employs machine vision (or image recognition technology) and content rules to curate a content collection automatically. In certain examples, compensation may be paid to a user to include user-generated content into a collection. In such cases, the collection management system 220 operates to automatically make payments to such users to use their content.

A map system 226 provides various geographic location (e.g., geolocation) functions and supports the presentation of map-based media content and messages by the interaction client 104. For example, the map system 226 enables the display of user icons or avatars (e.g., stored in profile data 302) on a map to indicate a current or past location of “friends” of a user, as well as media content (e.g., collections of messages including photographs and videos) generated by such friends, within the context of a map. For example, a message posted by a user to the interaction system 100 from a specific geographic location may be displayed within the context of a map at that particular location to “friends” of a specific user on a map interface of the interaction client 104. A user can furthermore share his or her location and status information (e.g., using an appropriate status avatar) with other users of the interaction system 100 via the interaction client 104, with this location and status information being similarly displayed within the context of a map interface of the interaction client 104 to selected users.

A game system 224 provides various gaming functions within the context of the interaction client 104. The interaction client 104 provides a game interface providing a list of available games that can be launched by a user within the context of the interaction client 104 and played with other users of the interaction system 100. The interaction system 100 further enables a particular user to invite other users to participate in the play of a specific game by issuing invitations to such other users from the interaction client 104. The interaction client 104 also supports audio, video, and text messaging (e.g., chats) within the context of gameplay, provides a leaderboard for the games, and also supports the provision of in-game rewards (e.g., coins and items).

An external resource system 226 provides an interface for the interaction client 104 to communicate with remote servers (e.g., third-party servers 112) to launch or access external resources, i.e., applications or applets. Each third-party server 112 hosts, for example, a markup language (e.g., HTML5) based application or a small-scale version of an application (e.g., game, utility, payment, or ride-sharing application). The interaction client 104 may launch a web-based resource (e.g., application) by accessing the HTML5 file from the third-party servers 112 associated with the web-based resource. Applications hosted by third-party servers 112 are programmed in JavaScript leveraging a Software Development Kit (SDK) provided by the interaction servers 124. The SDK includes Application Programming Interfaces (APIs) with functions that can be called or invoked by the web-based application. The interaction servers 124 host a JavaScript library that provides a given external resource access to specific user data of the interaction client 104. HTML5 is an example of technology for programming games, but applications and resources programmed based on other technologies can be used.

To integrate the functions of the SDK into the web-based resource, the SDK is downloaded by the third-party server 112 from the interaction servers 124 or is otherwise received by the third-party server 112. Once downloaded or received, the SDK is included as part of the application code of a web-based external resource. The code of the web-based resource can then call or invoke certain functions of the SDK to integrate features of the interaction client 104 into the web-based resource.

The SDK stored on the interaction server system 110 effectively provides the bridge between an external resource (e.g., applications 106 or applets) and the interaction client 104. This gives the user a seamless experience of communicating with other users on the interaction client 104 while also preserving the look and feel of the interaction client 104. To bridge communications between an external resource and an interaction client 104, the SDK facilitates communication between third-party servers 112 and the interaction client 104. A bridge script running on a user system 102 establishes two one-way communication channels between an external resource and the interaction client 104. Messages are sent between the external resource and the interaction client 104 via these communication channels asynchronously. Each SDK function invocation is sent as a message and callback. Each SDK function is implemented by constructing a unique callback identifier and sending a message with that callback identifier.

By using the SDK, not all information from the interaction client 104 is shared with third-party servers 112. The SDK limits which information is shared based on the needs of the external resource. Each third-party server 112 provides an HTML5 file corresponding to the web-based external resource to interaction servers 124. The interaction servers 124 can add a visual representation (such as a box art or other graphic) of the web-based external resource in the interaction client 104. Once the user selects the visual representation or instructs the interaction client 104 through a GUI of the interaction client 104 to access features of the web-based external resource, the interaction client 104 obtains the HTML5 file and instantiates the resources to access the features of the web-based external resource.

The interaction client 104 presents a graphical user interface (e.g., a landing page or title screen) for an external resource. During, before, or after presenting the landing page or title screen, the interaction client 104 determines whether the launched external resource has been previously authorized to access user data of the interaction client 104. In response to determining that the launched external resource has been previously authorized to access user data of the interaction client 104, the interaction client 104 presents another graphical user interface of the external resource that includes functions and features of the external resource. In response to determining that the launched external resource has not been previously authorized to access user data of the interaction client 104, after a threshold period of time (e.g., 3 seconds) of displaying the landing page or title screen of the external resource, the interaction client 104 slides up (e.g., animates a menu as surfacing from a bottom of the screen to a middle or other portion of the screen) a menu for authorizing the external resource to access the user data. The menu identifies the type of user data that the external resource will be authorized to use. In response to receiving a user selection of an accept option, the interaction client 104 adds the external resource to a list of authorized external resources and allows the external resource to access user data from the interaction client 104. The external resource is authorized by the interaction client 104 to access the user data under an OAuth 2 framework.

The interaction client 104 controls the type of user data that is shared with external resources based on the type of external resource being authorized. For example, external resources that include full-scale applications (e.g., an application 106) are provided with access to a first type of user data (e.g., two-dimensional avatars of users with or without different avatar characteristics). As another example, external resources that include small-scale versions of applications (e.g., web-based versions of applications) are provided with access to a second type of user data (e.g., payment information, two-dimensional avatars of users, three-dimensional avatars of users, and avatars with various avatar characteristics). Avatar characteristics include different ways to customize a look and feel of an avatar, such as different poses, facial features, clothing, and so forth.

An advertisement system 228 operationally enables the purchasing of advertisements by third parties for presentation to end-users via the interaction clients 104 and also handles the delivery and presentation of these advertisements.

An artificial intelligence and machine learning system 230 provides a variety of services to different subsystems within the interaction system 100. For example, the artificial intelligence and machine learning system 230 operates with the image processing system 202 and the camera system 204 to analyze images and extract information such as objects, text, or faces. This information can then be used by the image processing system 202 to enhance, filter, or manipulate images. The artificial intelligence and machine learning system 230 may be used by the augmentation system 206 to generate augmented content and augmented reality experiences, such as adding virtual objects or animations to real-world images. The communication system 208 and messaging system 210 may use the artificial intelligence and machine learning system 230 to analyze communication patterns and provide insights into how users interact with each other and provide intelligent message classification and tagging, such as categorizing messages based on sentiment or topic. The artificial intelligence and machine learning system 230 may also provide chatbot functionality to message interactions 120 between user systems 102 and between a user system 102 and the interaction server system 110. The artificial intelligence and machine learning system 230 may also work with the audio communication system 216 to provide speech recognition and natural language processing capabilities, allowing users to interact with the interaction system 100 using voice commands.

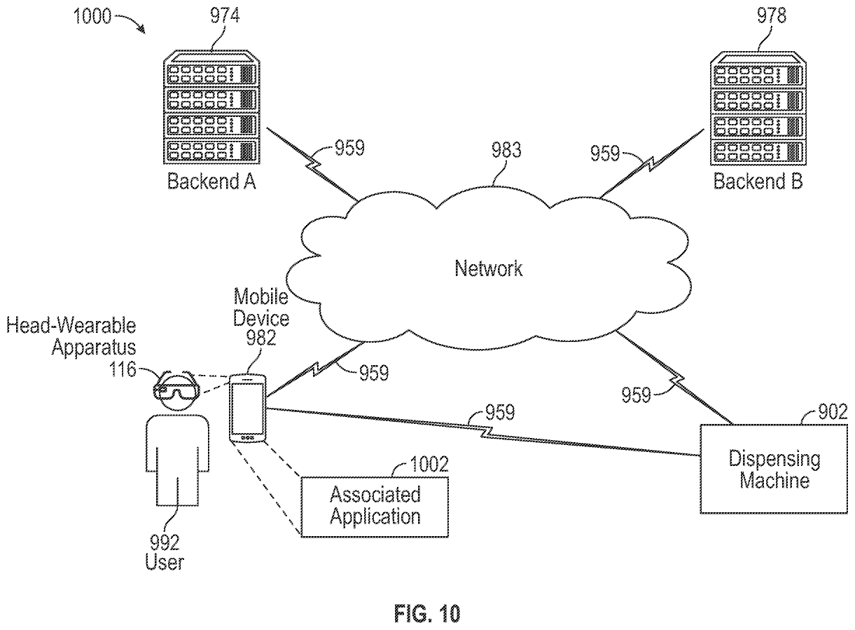

The dispensing machine system 234 supports system 900 for AR activated dispensing machine. The dispensing machine system 234, referring to FIGS. 9 and 10, the functions associated with the 3D presentation module 989 and rendering module 957, in accordance with some examples. Additionally, the dispensing machine system 234 may act as an intermediary for sending data between the mobile device 982, the backend A 974, the backend B 978, and the dispensing machine 902. In some examples, the dispensing machine system 234 performs one or more functions described in conjunction with system 900. The dispensing machine system 234 additionally provides support for sharing videos and codes and access to social media accounts.

### Date Architecture

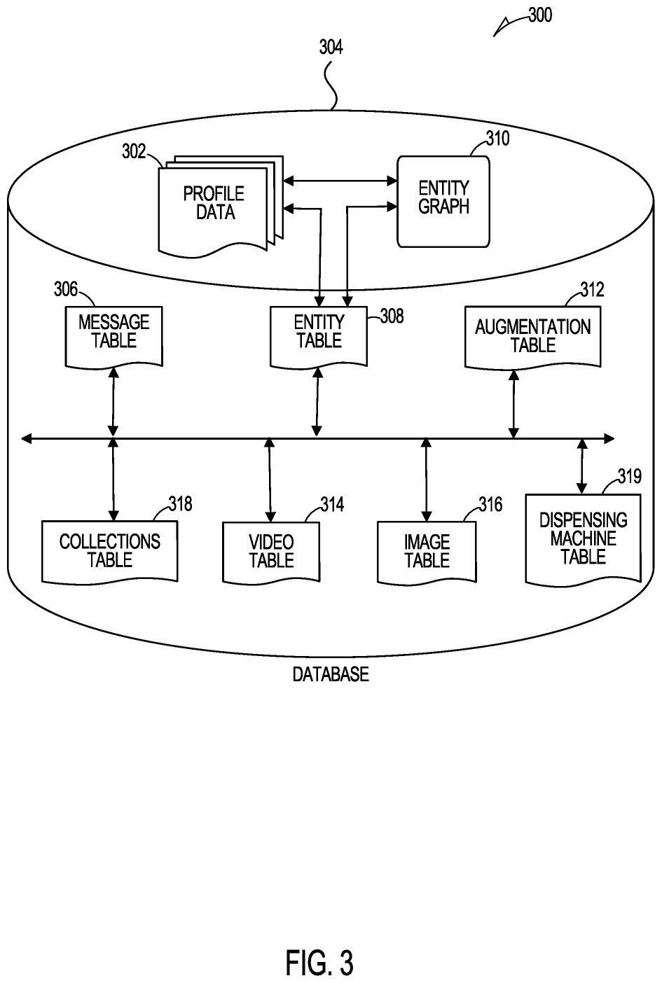

FIG. 3 is a schematic diagram illustrating data structures 300, which may be stored in the database 304 of the interaction server system 110, according to certain examples. While the content of the database 304 is shown to comprise multiple tables, it will be appreciated that the data could be stored in other types of data structures (e.g., as an object-oriented database).

The database 304 includes message data stored within a message table 306. This message data includes, for any particular message, at least message sender data, message recipient (or receiver) data, and a payload. Further details regarding information that may be included in a message, and included within the message data stored in the message table 306, are described below with reference to FIG. 3.

An entity table 308 stores entity data, and is linked (e.g., referentially) to an entity graph 310 and profile data 302. Entities for which records are maintained within the entity table 308 may include individuals, corporate entities, organizations, objects, places, events, and so forth. Regardless of entity type, any entity regarding which the interaction server system 110 stores data may be a recognized entity. Each entity is provided with a unique identifier, as well as an entity type identifier (not shown).

The entity graph 310 stores information regarding relationships and associations between entities. Such relationships may be social, professional (e.g., work at a common corporation or organization), interest-based, or activity-based, merely for example. Certain relationships between entities may be unidirectional, such as a subscription by an individual user to digital content of a commercial or publishing user (e.g., a newspaper or other digital media outlet, or a brand). Other relationships may be bidirectional, such as a “friend” relationship between individual users of the interaction system 100.

Certain permissions and relationships may be attached to each relationship, and also to each direction of a relationship. For example, a bidirectional relationship (e.g., a friend relationship between individual users) may include authorization for the publication of digital content items between the individual users, but may impose certain restrictions or filters on the publication of such digital content items (e.g., based on content characteristics, location data or time of day data). Similarly, a subscription relationship between an individual user and a commercial user may impose different degrees of restrictions on the publication of digital content from the commercial user to the individual user, and may significantly restrict or block the publication of digital content from the individual user to the commercial user. A particular user, as an example of an entity, may record certain restrictions (e.g., by way of privacy settings) in a record for that entity within the entity table 308. Such privacy settings may be applied to all types of relationships within the context of the interaction system 100, or may selectively be applied to certain types of relationships.

The profile data 302 stores multiple types of profile data about a particular entity. The profile data 302 may be selectively used and presented to other users of the interaction system 100 based on privacy settings specified by a particular entity. Where the entity is an individual, the profile data 302 includes, for example, a user name, telephone number, address, settings (e.g., notification and privacy settings), as well as a user-selected avatar representation (or collection of such avatar representations). A particular user may then selectively include one or more of these avatar representations within the content of messages communicated via the interaction system 100, and on map interfaces displayed by interaction clients 104 to other users. The collection of avatar representations may include “status avatars,” which present a graphical representation of a status or activity that the user may select to communicate at a particular time.

Where the entity is a group, the profile data 302 for the group may similarly include one or more avatar representations associated with the group, in addition to the group name, members, and various settings (e.g., notifications) for the relevant group.

The database 304 also stores augmentation data, such as overlays or filters, in an augmentation table 312. The augmentation data is associated with and applied to videos (for which data is stored in a video table 314) and images (for which data is stored in an image table 316).

Filters, in some examples, are overlays that are displayed as overlaid on an image or video during presentation to a recipient user. Filters may be of various types, including user-selected filters from a set of filters presented to a sending user by the interaction client 104 when the sending user is composing a message. Other types of filters include geolocation filters (also known as geo-filters), which may be presented to a sending user based on geographic location. For example, geolocation filters specific to a neighborhood or special location may be presented within a user interface by the interaction client 104, based on geolocation information determined by a Global Positioning System (GPS) unit of the user system 102.

Another type of filter is a data filter, which may be selectively presented to a sending user by the interaction client 104 based on other inputs or information gathered by the user system 102 during the message creation process. Examples of data filters include current temperature at a specific location, a current speed at which a sending user is traveling, battery life for a user system 102, or the current time.

Other augmentation data that may be stored within the image table 316 includes augmented reality content items (e.g., corresponding to applying “lenses” or augmented reality experiences). An augmented reality content item may be a real-time special effect and sound that may be added to an image or a video.

A collections table 318 stores data regarding collections of messages and associated image, video, or audio data, which are compiled into a collection (e.g., a story or a gallery). The creation of a particular collection may be initiated by a particular user (e.g., each user for which a record is maintained in the entity table 308). A user may create a “personal story” in the form of a collection of content that has been created and sent/broadcast by that user. To this end, the user interface of the interaction client 104 may include an icon that is user-selectable to enable a sending user to add specific content to his or her personal story.

A collection may also constitute a “live story,” which is a collection of content from multiple users that is created manually, automatically, or using a combination of manual and automatic techniques. For example, a “live story” may constitute a curated stream of user-submitted content from various locations and events. Users whose client devices have location services enabled and are at a common location event at a particular time may, for example, be presented with an option, via a user interface of the interaction client 104, to contribute content to a particular live story. The live story may be identified to the user by the interaction client 104, based on his or her location. The end result is a “live story” told from a community perspective.

A further type of content collection is known as a “location story,” which enables a user whose user system 102 is located within a specific geographic location (e.g., on a college or university campus) to contribute to a particular collection. In some examples, a contribution to a location story may employ a second degree of authentication to verify that the end-user belongs to a specific organization or other entity (e.g., is a student on the university campus).

As mentioned above, the video table 314 stores video data that, in some examples, is associated with messages for which records are maintained within the message table 306. Similarly, the image table 316 stores image data associated with messages for which message data is stored in the entity table 308. The entity table 308 may associate various augmentations from the augmentation table 312 with various images and videos stored in the image table 316 and the video table 314.

The databases 304 also includes dispensing machine table 319. The dispensing machine table 319 includes, referring to FIG. 9, applications 924, content items 943, vending items 925, processed graphics 945, avatars 951, codes, generated music and other videos for the user 992, and so forth.

### Data Communications Architecture

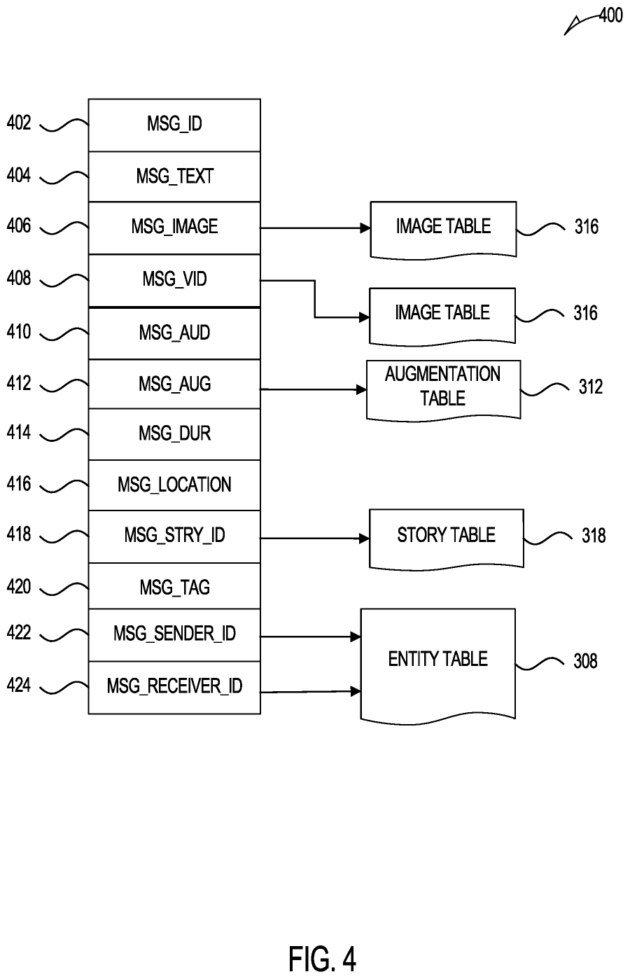

FIG. 4 is a schematic diagram illustrating a structure of a message 400, according to some examples, generated by an interaction client 104 for communication to a further interaction client 104 via the interaction servers 124. The content of a particular message 400 is used to populate the message table 306 stored within the database 304, accessible by the interaction servers 124. Similarly, the content of a message 400 is stored in memory as “in-transit” or “in-flight” data of the user system 102 or the interaction servers 124. A message 400 is shown to include the following example components:
Message identifier 402: a unique identifier that identifies the message 400.
Message text payload 404: text, to be generated by a user via a user interface of the user system 102, and that is included in the message 400.
Message image payload 406: image data, captured by a camera component of a user system 102 or retrieved from a memory component of a user system 102, and that is included in the message 400. Image data for a sent or received message 400 may be stored in the image table 316.
Message video payload 408: video data, captured by a camera component or retrieved from a memory component of the user system 102, and that is included in the message 400. Video data for a sent or received message 400 may be stored in the image table 316.
Message audio payload 410: audio data, captured by a microphone or retrieved from a memory component of the user system 102, and that is included in the message 400.
Message augmentation data 412: augmentation data (e.g., filters, stickers, or other annotations or enhancements) that represents augmentations to be applied to message image payload 406, message video payload 408, or message audio payload 410 of the message 400. Augmentation data for a sent or received message 400 may be stored in the augmentation table 312.
Message duration parameter 414: parameter value indicating, in seconds, the amount of time for which content of the message (e.g., the message image payload 406, message video payload 408, message audio payload 410) is to be presented or made accessible to a user via the interaction client 104.
Message geolocation parameter 416: geolocation data (e.g., latitudinal and longitudinal coordinates) associated with the content payload of the message. Multiple message geolocation parameter 416 values may be included in the payload, each of these parameter values being associated with respect to content items included in the content (e.g., a specific image within the message image payload 406, or a specific video in the message video payload 408).
Message story identifier 418: identifier values identifying one or more content collections (e.g., “stories” identified in the collections table 318) with which a particular content item in the message image payload 406 of the message 400 is associated. For example, multiple images within the message image payload 406 may each be associated with multiple content collections using identifier values.
Message tag 420: each message 400 may be tagged with multiple tags, each of which is indicative of the subject matter of content included in the message payload. For example, where a particular image included in the message image payload 406 depicts an animal (e.g., a lion), a tag value may be included within the message tag 420 that is indicative of the relevant animal. Tag values may be generated manually, based on user input, or may be automatically generated using, for example, image recognition.
Message sender identifier 422: an identifier (e.g., a messaging system identifier, email address, or device identifier) indicative of a user of the user system 102 on which the message 400 was generated and from which the message 400 was sent.
Message receiver identifier 424: an identifier (e.g., a messaging system identifier, email address, or device identifier) indicative of a user of the user system 102 to which the message 400 is addressed.

The contents (e.g., values) of the various components of message 400 may be pointers to locations in tables within which content data values are stored. For example, an image value in the message image payload 406 may be a pointer to (or address of) a location within an image table 316. Similarly, values within the message video payload 408 may point to data stored within an image table 316, values stored within the message augmentation data 412 may point to data stored in an augmentation table 312, values stored within the message story identifier 418 may point to data stored in a collections table 318, and values stored within the message sender identifier 422 and the message receiver identifier 424 may point to user records stored within an entity table 308.

### System With Head-Wearable Apparatus

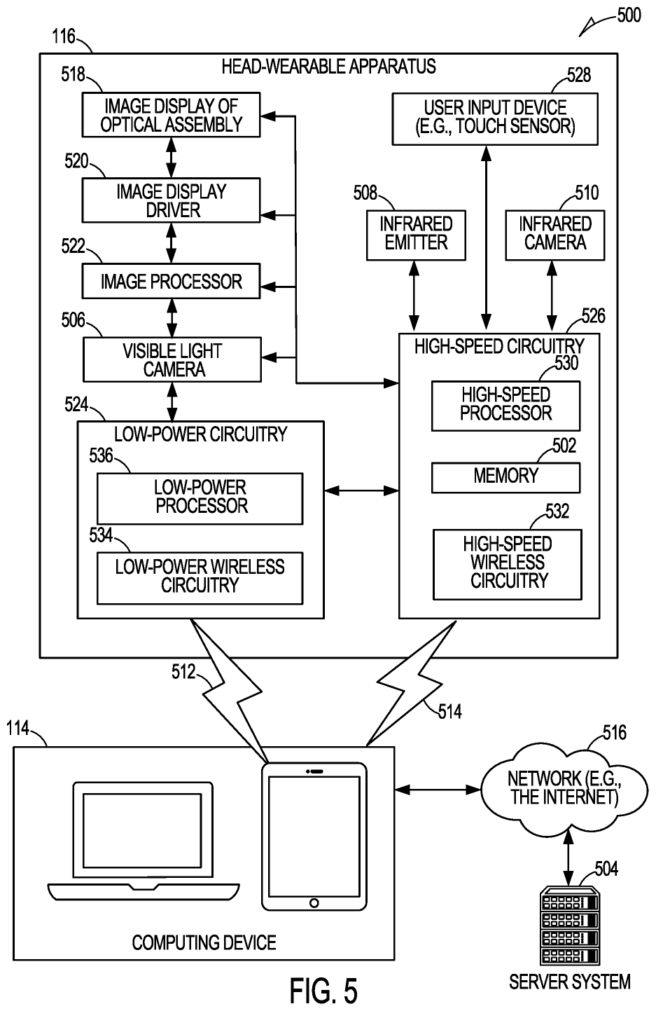

FIG. 5 illustrates a system 500 including a head-wearable apparatus 116 with a selector input device, according to some examples. FIG. 5 is a high-level functional block diagram of an example head-wearable apparatus 116 communicatively coupled to a computing device 114 and various server systems 504 (e.g., the interaction server system 110) via various networks 108.

The head-wearable apparatus 116 includes one or more cameras, each of which may be, for example, a visible light camera 506, an infrared emitter 508, and an infrared camera 510.

The computing device 114 connects with head-wearable apparatus 116 using both a low-power wireless connection 512 and a high-speed wireless connection 514. The computing device 114 is also connected to the server system 504 and the network 516, in accordance with some examples. The computing device 114 may be a portable computing device such as a smart phone, tablet, laptop, or another type of computing device 114 such as a desktop computer, or another type of computing device 114.

The head-wearable apparatus 116 further includes two image displays of the image display of optical assembly 518. The two image displays of optical assembly 518 include one associated with the left lateral side and one associated with the right lateral side of the head-wearable apparatus 116. The head-wearable apparatus 116 also includes an image display driver 520, an image processor 522, low-power circuitry 524, and high-speed circuitry 526. The image display of optical assembly 518 is for presenting images and videos, including an image that can include a graphical user interface to a user of the head-wearable apparatus 116.

The image display driver 520 commands and controls the image display of optical assembly 518. The image display driver 520 may deliver image data directly to the image display of optical assembly 518 for presentation or may convert the image data into a signal or data format suitable for delivery to the image display device. For example, the image data may be video data formatted according to compression formats, such as H.264 (MPEG-4 Part 10), HEVC, Theora, Dirac, RealVideo RV40, VP8, VP9, or the like, and still image data may be formatted according to compression formats such as Portable Network Group (PNG), Joint Photographic Experts Group (JPEG), Tagged Image File Format (TIFF) or exchangeable image file format (EXIF) or the like.

The head-wearable apparatus 116 includes a frame and stems (or temples) extending from a lateral side of the frame. The head-wearable apparatus 116 further includes a user input device 528 (e.g., touch sensor or push button), including an input surface on the head-wearable apparatus 116. The user input device 528 (e.g., touch sensor or push button) is to receive from the user an input selection to manipulate the graphical user interface of the presented image.

The components shown in FIG. 5 for the head-wearable apparatus 116 are located on one or more circuit boards, for example a PCB or flexible PCB, in the rims or temples. Alternatively, or additionally, the depicted components can be located in the chunks, frames, hinges, or bridge of the head-wearable apparatus 116. Left and right visible light cameras 506 can include digital camera elements such as a complementary metal oxide-semiconductor (CMOS) image sensor, charge-coupled device, camera lenses, or any other respective visible or light-capturing elements that may be used to capture data, including images of scenes with unknown objects.

The head-wearable apparatus 116 includes a memory 502, which stores instructions to perform a subset or all of the functions described herein. The memory 502 can also include storage device.

As shown in FIG. 5, the high-speed circuitry 526 includes a high-speed processor 530, a memory 502, and high-speed wireless circuitry 532. In some examples, the image display driver 520 is coupled to the high-speed circuitry 526 and operated by the high-speed processor 530 in order to drive the left and right image displays of the image display of optical assembly 518. The high-speed processor 530 may be any processor capable of managing high-speed communications and operation of any general computing system needed for the head-wearable apparatus 116. The high-speed processor 530 includes processing resources needed for managing high-speed data transfers on a high-speed wireless connection 514 to a wireless local area network (WLAN) using the high-speed wireless circuitry 532. In certain examples, the high-speed processor 530 executes an operating system such as a LINUX operating system or other such operating system of the head-wearable apparatus 116, and the operating system is stored in the memory 502 for execution. In addition to any other responsibilities, the high-speed processor 530 executing a software architecture for the head-wearable apparatus 116 is used to manage data transfers with high-speed wireless circuitry 532. In certain examples, the high-speed wireless circuitry 532 is configured to implement Institute of Electrical and Electronic Engineers (IEEE) 802.11 communication standards, also referred to herein as WI-FI®. In some examples, other high-speed communications standards may be implemented by the high-speed wireless circuitry 532.

The low-power wireless circuitry 534 and the high-speed wireless circuitry 532 of the head-wearable apparatus 116 can include short-range transceivers (BLUETOOTH®) and wireless wide, local, or wide area network transceivers (e.g., cellular or WI-FI®). Computing device 114, including the transceivers communicating via the low-power wireless connection 512 and the high-speed wireless connection 514, may be implemented using details of the architecture of the head-wearable apparatus 116, as can other elements of the network 516.

The memory 502 includes any storage device capable of storing various data and applications, including, among other things, camera data generated by the left and right visible light cameras 506, the infrared camera 510, and the image processor 522, as well as images generated for display by the image display driver 520 on the image displays of the image display of optical assembly 518. While the memory 502 is shown as integrated with high-speed circuitry 526, in some examples, the memory 502 may be an independent standalone element of the head-wearable apparatus 116. In certain such examples, electrical routing lines may provide a connection through a chip that includes the high-speed processor 530 from the image processor 522 or the low-power processor 536 to the memory 502. In some examples, the high-speed processor 530 may manage addressing of the memory 502 such that the low-power processor 536 will boot the high-speed processor 530 any time that a read or write operation involving memory 502 is needed.

As shown in FIG. 5, the low-power processor 536 or high-speed processor 530 of the head-wearable apparatus 116 can be coupled to the camera (visible light camera 506, infrared emitter 508, or infrared camera 510), the image display driver 520, the user input device 528 (e.g., touch sensor or push button), and the memory 502.

The head-wearable apparatus 116 is connected to a host computer. For example, the head-wearable apparatus 116 is paired with the computing device 114 via the high-speed wireless connection 514 or connected to the server system 504 via the network 516. The server system 504 may be one or more computing devices as part of a service or network computing system, for example, that includes a processor, a memory, and network communication interface to communicate over the network 516 with the computing device 114 and the head-wearable apparatus 116.

The computing device 114 includes a processor and a network communication interface coupled to the processor. The network communication interface allows for communication over the network 516, low-power wireless connection 512, or high-speed wireless connection 514. Computing device 114 can further store at least portions of the instructions for generating binaural audio content in the computing device 114′s memory to implement the functionality described herein.

Output components of the head-wearable apparatus 116 include visual components, such as a display such as a liquid crystal display (LCD), a plasma display panel (PDP), a light-emitting diode (LED) display, a projector, or a waveguide. The image displays of the optical assembly are driven by the image display driver 520. The output components of the head-wearable apparatus 116 further include acoustic components (e.g., speakers), haptic components (e.g., a vibratory motor), other signal generators, and so forth. The input components of the head-wearable apparatus 116, the computing device 114, and server system 504, such as the user input device 528, may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

The head-wearable apparatus 116 may also include additional peripheral device elements. Such peripheral device elements may include biometric sensors, additional sensors, or display elements integrated with the head-wearable apparatus 116. For example, peripheral device elements may include any I/O components including output components, motion components, position components, or any other such elements described herein.

For example, the biometric components include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The biometric components may include a brain-machine interface (BMI) system that allows communication between the brain and an external device or machine. This may be achieved by recording brain activity data, translating this data into a format that can be understood by a computer, and then using the resulting signals to control the device or machine.

Example types of BMI technologies, including:
Electroencephalography (EEG) based BMIs, which record electrical activity in the brain using electrodes placed on the scalp.
Invasive BMIs, which used electrodes that are surgically implanted into the brain.
Optogenetics BMIs, which use light to control the activity of specific nerve cells in the brain.

Any biometric data collected by the biometric components is captured and stored with only user approval and deleted on user request. Further, such biometric data may be used for very limited purposes, such as identification verification. To ensure limited and authorized use of biometric information and other personally identifiable information (PII), access to this data is restricted to authorized personnel only, if at all. Any use of biometric data may strictly be limited to identification verification purposes, and the biometric data is not shared or sold to any third party without the explicit consent of the user. In addition, appropriate technical and organizational measures are implemented to ensure the security and confidentiality of this sensitive information.

The motion components include acceleration sensor components (e.g., accelerometer), gravitation sensor components, rotation sensor components (e.g., gyroscope), and so forth. The position components include location sensor components to generate location coordinates (e.g., a Global Positioning System (GPS) receiver component), WI-FI® or BLUETOOTH® transceivers to generate positioning system coordinates, altitude sensor components (e.g., altimeters or barometers that detect air pressure from which altitude may be derived), orientation sensor components (e.g., magnetometers), and the like. Such positioning system coordinates can also be received over low-power wireless connections 512 and high-speed wireless connection 514 from the computing device 114 via the low-power wireless circuitry 534 or high-speed wireless circuitry 532.

### Machine Architecture

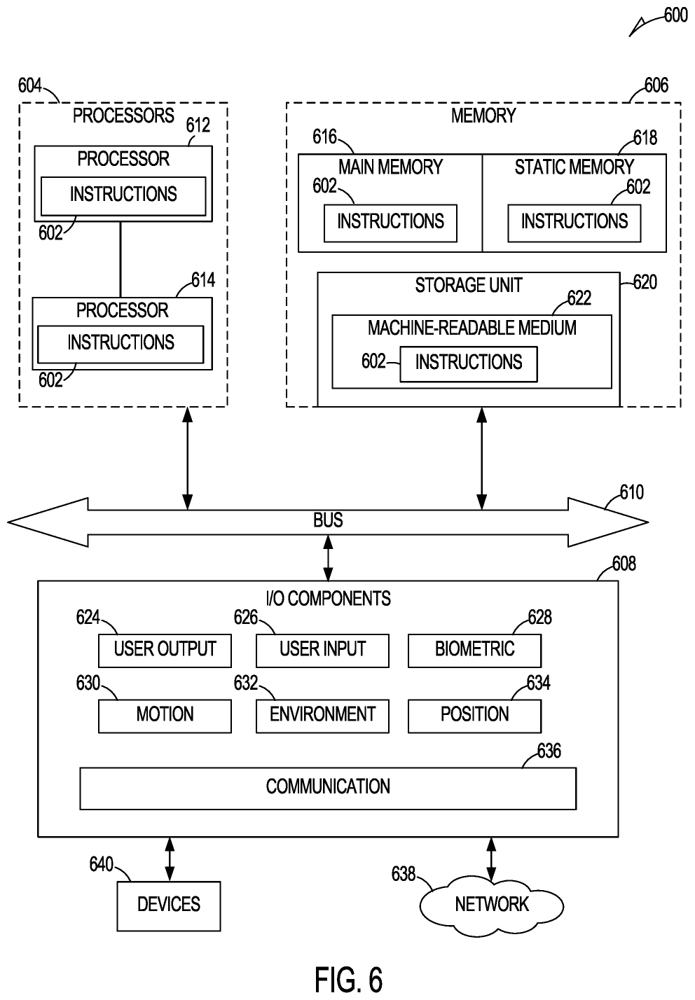

FIG. 6 is a diagrammatic representation of the machine 600 within which instructions 602 (e.g., software, a program, an application, an applet, an app, or other executable code) for causing the machine 600 to perform any one or more of the methodologies discussed herein may be executed. For example, the instructions 602 may cause the machine 600 to execute any one or more of the methods described herein. The instructions 602 transform the general, non-programmed machine 600 into a particular machine 600 programmed to carry out the described and illustrated functions in the manner described. The machine 600 may operate as a standalone device or may be coupled (e.g., networked) to other machines. In a networked deployment, the machine 600 may operate in the capacity of a server machine or a client machine in a server-client network environment, or as a peer machine in a peer-to-peer (or distributed) network environment. The machine 600 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 602, sequentially or otherwise, that specify actions to be taken by the machine 600. Further, while a single machine 600 is illustrated, the term “machine”shall also be taken to include a collection of machines that individually or jointly execute the instructions 602 to perform any one or more of the methodologies discussed herein. The machine 600, for example, may comprise the user system 102 or any one of multiple server devices forming part of the interaction server system 110. In some examples, the machine 600 may also comprise both client and server systems, with certain operations of a particular method or algorithm being performed on the server-side and with certain operations of the particular method or algorithm being performed on the client-side.

The machine 600 may include processors 604, memory 606, and input/output I/O components 608, which may be configured to communicate with each other via a bus 610. In an example, the processors 604 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 612 and a processor 614 that execute the instructions 602. The term “processor” is intended to include multi-core processors that may comprise two or more independent processors (sometimes referred to as “cores”) that may execute instructions contemporaneously. Although FIG. 6 shows multiple processors 604, the machine 600 may include a single processor with a single-core, a single processor with multiple cores (e.g., a multi-core processor), multiple processors with a single core, multiple processors with multiples cores, or any combination thereof.

The memory 606 includes a main memory 616, a static memory 618, and a storage unit 620, both accessible to the processors 604 via the bus 610. The main memory 606, the static memory 618, and storage unit 620 store the instructions 602 embodying any one or more of the methodologies or functions described herein. The instructions 602 may also reside, completely or partially, within the main memory 616, within the static memory 618, within machine-readable medium 622 within the storage unit 620, within at least one of the processors 604 (e.g., within the processor's cache memory), or any suitable combination thereof, during execution thereof by the machine 600.

The I/O components 608 may include a wide variety of components to receive input, provide output, produce output, transmit information, exchange information, capture measurements, and so on. The specific I/O components 608 that are included in a particular machine will depend on the type of machine. For example, portable machines such as mobile phones may include a touch input device or other such input mechanisms, while a headless server machine will likely not include such a touch input device. It will be appreciated that the I/O components 608 may include many other components that are not shown in FIG. 6. In various examples, the I/O components 608 may include user output components 624 and user input components 626. The user output components 624 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 626 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 608 may include biometric components 628, motion components 630, environmental components 632, or position components 634, among a wide array of other components. For example, the biometric components 628 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The biometric components may include a brain-machine interface (BMI) system that allows communication between the brain and an external device or machine. This may be achieved by recording brain activity data, translating this data into a format that can be understood by a computer, and then using the resulting signals to control the device or machine.

Example types of BMI technologies, including:
Electroencephalography (EEG) based BMIs, which record electrical activity in the brain using electrodes placed on the scalp.
Invasive BMIs, which used electrodes that are surgically implanted into the brain.
Optogenetics BMIs, which use light to control the activity of specific nerve cells in the brain.

Any biometric data collected by the biometric components is captured and stored only with user approval and deleted on user request. Further, such biometric data may be used for very limited purposes, such as identification verification. To ensure limited and authorized use of biometric information and other personally identifiable information (PII), access to this data is restricted to authorized personnel only, if at all. Any use of biometric data may strictly be limited to identification verification purposes, and the data is not shared or sold to any third party without the explicit consent of the user. In addition, appropriate technical and organizational measures are implemented to ensure the security and confidentiality of this sensitive information.

The motion components 630 include acceleration sensor components (e.g., accelerometer), gravitation sensor components, rotation sensor components (e.g., gyroscope).

The environmental components 632 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the user system 102 may have a camera system comprising, for example, front cameras on a front surface of the user system 102 and rear cameras on a rear surface of the user system 102. The front cameras may, for example, be used to capture still images and video of a user of the user system 102 (e.g., “selfies”), which may then be augmented with augmentation data (e.g., filters) described above. The rear cameras may, for example, be used to capture still images and videos in a more traditional camera mode, with these images similarly being augmented with augmentation data. In addition to front and rear cameras, the user system 102 may also include a 360° Camera for capturing 360° photographs and videos.

Further, the camera system of the user system 102 may include dual rear cameras (e.g., a primary camera as well as a depth-sensing camera), or even triple, quad or penta rear camera configurations on the front and rear sides of the user system 102. These multiple cameras systems may include a wide camera, an ultra-wide camera, a telephoto camera, a macro camera, and a depth sensor, for example.

The position components 634 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 608 further include communication components 636 operable to couple the machine 600 to a network 638 or devices 640 via respective coupling or connections. For example, the communication components 636 may include a network interface component or another suitable device to interface with the network 638. In further examples, the communication components 636 may include wired communication components, wireless communication components, cellular communication components, Near Field Communication (NFC) components, BLUETOOTH® components (e.g., BLUETOOTH® Low Energy), WI-FI® components, and other communication components to provide communication via other modalities. The devices 640 may be another machine or any of a wide variety of peripheral devices (e.g., a peripheral device coupled via a USB).

Moreover, the communication components 636 may detect identifiers or include components operable to detect identifiers. For example, the communication components 636 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information may be derived via the communication components 636, such as location via Internet Protocol (IP) geolocation, location via WI-FI® signal triangulation, location via detecting an NFC beacon signal that may indicate a particular location, and so forth.

The various memories (e.g., main memory 616, static memory 618, and memory of the processors 604) and storage unit 620 may store one or more sets of instructions and data structures (e.g., software) embodying or used by any one or more of the methodologies or functions described herein. These instructions (e.g., the instructions 602), when executed by processors 604, cause various operations to implement the disclosed examples.

The instructions 602 may be transmitted or received over the network 638, using a transmission medium, via a network interface device (e.g., a network interface component included in the communication components 636) and using any one of several well-known transfer protocols (e.g., hypertext transfer protocol (HTTP)). Similarly, the instructions 602 may be transmitted or received using a transmission medium via a coupling (e.g., a peer-to-peer coupling) to the devices 640.

### Software Architecture

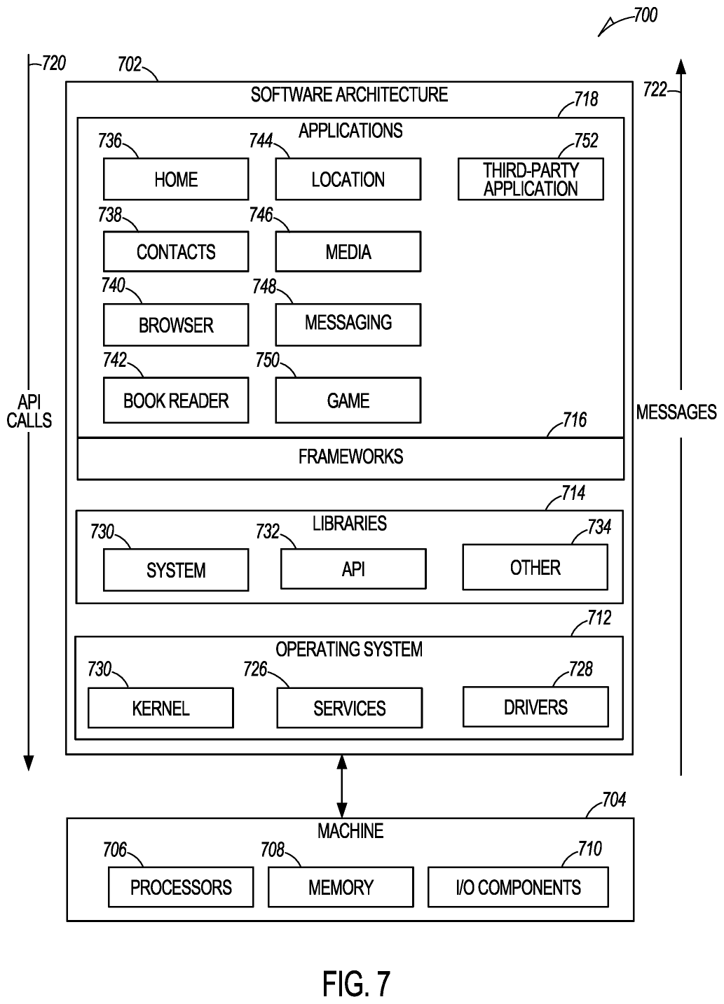

FIG. 7 is a block diagram 700 illustrating a software architecture 702, which can be installed on any one or more of the devices described herein. The software architecture 702 is supported by hardware such as a machine 704 that includes processors 706, memory 708, and I/O components 710. In this example, the software architecture 702 can be conceptualized as a stack of layers, where each layer provides a particular functionality. The software architecture 702 includes layers such as an operating system 712, libraries 714, frameworks 716, and applications 718. Operationally, the applications 718 invoke API calls 720 through the software stack and receive messages 722 in response to the API calls 720.

The operating system 712 manages hardware resources and provides common services. The operating system 712 includes, for example, a kernel 724, services 726, and drivers 728. The kernel 724 acts as an abstraction layer between the hardware and the other software layers. For example, the kernel 724 provides memory management, processor management (e.g., scheduling), component management, networking, and security settings, among other functionalities. The services 726 can provide other common services for the other software layers. The drivers 728 are responsible for controlling or interfacing with the underlying hardware. For instance, the drivers 728 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 714 provide a common low-level infrastructure used by the applications 718. The libraries 714 can include system libraries 730 (e.g., C standard library) that provide functions such as memory allocation functions, string manipulation functions, mathematic functions, and the like. In addition, the libraries 714 can include API libraries 732 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 714 can also include a wide variety of other libraries 734 to provide many other APIs to the applications 718.

The frameworks 716 provide a common high-level infrastructure that is used by the applications 718. For example, the frameworks 716 provide various graphical user interface (GUI) functions, high-level resource management, and high-level location services. The frameworks 716 can provide a broad spectrum of other APIs that can be used by the applications 718, some of which may be specific to a particular operating system or platform.

In an example, the applications 718 may include a home application 736, a contacts application 738, a browser application 740, a book reader application 742, a location application 744, a media application 746, a messaging application 748, a game application 750, and a broad assortment of other applications such as a third-party application 752. The applications 718 are programs that execute functions defined in the programs. Various programming languages can be employed to create one or more of the applications 718, structured in a variety of manners, such as object-oriented programming languages (e.g., Objective-C, Java, or C++) or procedural programming languages (e.g., C or assembly language). In a specific example, the third-party application 752 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 752 can invoke the API calls 720 provided by the operating system 712 to facilitate functionalities described herein.

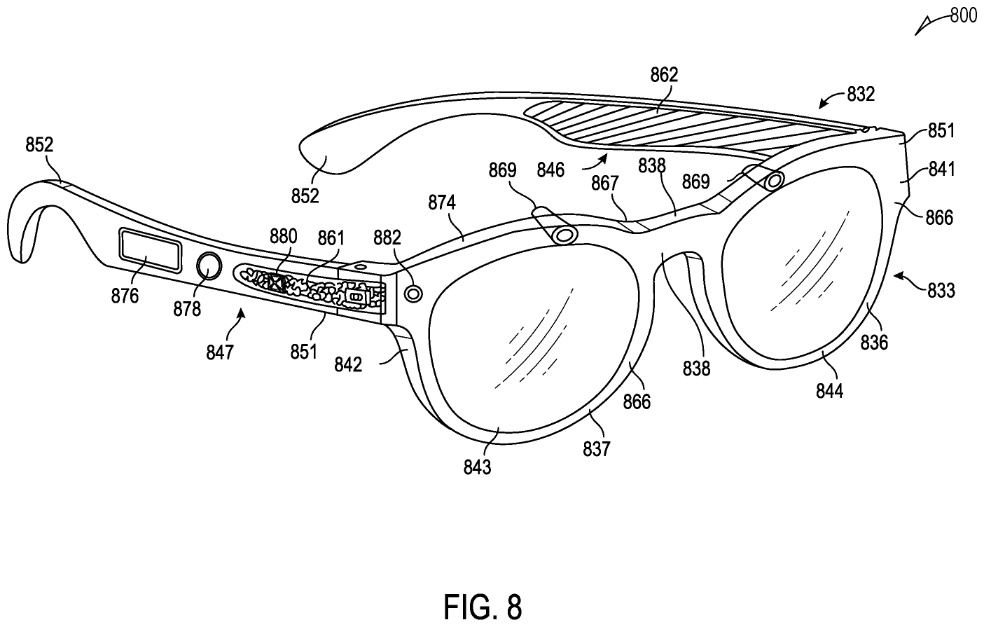

FIG. 8 is a perspective view of a head-wearable apparatus in the form of glasses 800, in accordance with some examples. The glasses 800 are an article of eyewear including electronics, which operate within a network system for communicating image and video content. FIG. 8 illustrates an example of the head-wearable apparatus 116. In some examples, the wearable electronic device is termed AR glasses. The glasses 800 can include a frame 832 made from any suitable material such as plastic or metal, including any suitable shape memory alloy. The frame 832 can have a front piece 833 that can include a first or left lens, display, or optical element holder 836 and a second or right lens, display, or optical element holder 837 connected by a bridge 838. The front piece 833 additionally includes a left end portion 841 and a right end portion 842. A first or left optical element 844 and a second or right optical clement 843 can be provided within respective left and right optical element holders 836, 837. Each of the optical elements 843, 844 can be a lens, a display, a display assembly, or a combination of the foregoing. In some examples, for example, the glasses 800 are provided with an integrated near-eye display mechanism that enables, for example, display to the user of preview images for visual media captured by cameras 869 of the glasses 800.

The frame 832 additionally includes a left arm or temple piece 846 and a right arm or temple piece 847 coupled to the respective left and right end portions 841, 842 of the front piece 833 by any suitable means such as a hinge (not shown), so as to be coupled to the front piece 833, or rigidly or fixedly secured to the front piece 833 so as to be integral with the front piece 833. Each of the temple pieces 846 and 847 can include a first portion 851 that is coupled to the respective end portion 841 or 842 of the front piece 833 and any suitable second portion 852, such as a curved or arcuate piece, for coupling to the car of the user. In one example, the front piece 833 can be formed from a single piece of material, so as to have a unitary or integral construction. In one example, the entire frame 832 can be formed from a single piece of material so as to have a unitary or integral construction.

The glasses 800 include a computing device, such as a computer 861, which can be of any suitable type so as to be carried by the frame 832 and, in one example, of a suitable size and shape, so as to be at least partially disposed in one or more of the temple pieces 846 and 847. In one example, the computer 861 has a size and shape similar to the size and shape of one of the temple pieces 846, 847 and is thus disposed almost entirely if not entirely within the structure and confines of such temple pieces 846 and 847.

In one example, the computer 861 can be disposed in both of the temple pieces 846, 847. The computer 861 can include one or more processors with memory, wireless communication circuitry, and a power source. The computer 861 comprises low-power circuitry, high-speed circuitry, location circuitry, and a display processor. Various other examples may include these elements in different configurations or integrated together in different ways. Additional details of aspects of the computer 861 may be implemented as described with reference to the description that follows.

The computer 861 additionally includes a battery 862 or other suitable portable power supply. In one example, the battery 862 is disposed in one of the temple pieces 846 or 847. In the glasses 800 shown in FIG. 8, the battery 862 is shown as being disposed in the left temple piece 846 and electrically coupled using a connection 874 to the remainder of the computer 861 disposed in the right temple piece 847. One or more input and output devices can include a connector or port (not shown) suitable for charging a battery 862 accessible from the outside of the frame 832, a wireless receiver, transmitter, or transceiver (not shown), or a combination of such devices.

The glasses 800 include digital cameras 869. Although two cameras 869 are depicted, other examples contemplate the use of a single or additional (i.e., more than two) cameras 869. For ease of description, various features relating to the cameras 869 will be described further with reference to only a single camera 869, but it will be appreciated that these features can apply, in suitable examples, to both cameras 869.

In various examples, the glasses 800 may include any number of input sensors or peripheral devices in addition to the cameras 869. The front piece 833 is provided with an outward-facing, forward-facing, front, or outer surface 866 that faces forward or away from the user when the glasses 800 are mounted on the face of the user, and an opposite inward-facing, rearward-facing, rear, or inner surface 867 that faces the face of the user when the glasses 800 are mounted on the face of the user. Such sensors can include inward-facing video sensors or digital imaging modules such as cameras 869 that can be mounted on or provided within the inner surface 867 of the front piece 833 or elsewhere on the frame 832 so as to be facing the user, and outward-facing video sensors or digital imaging modules such as the cameras 869 that can be mounted on or provided with the outer surface 866 of the front piece 833 or elsewhere on the frame 832 so as to be facing away from the user. Such sensors, peripheral devices, or peripherals can additionally include biometric sensors, location sensors, accelerometers, or any other such sensors. In some examples, projectors (not illustrated) are used to project images on the inner surface of the optical elements 843, 844 (or lenses) to provide a mixed reality or augmented reality experience for the user of the glasses 800.

The glasses 800 further include an example of a camera control mechanism or user input mechanism comprising a camera control button mounted on the frame 832 for haptic or manual engagement by the user. The camera control button provides a bi-modal or single-action mechanism in that it is disposable by the user between only two conditions, namely an engaged condition and a disengaged condition. In this example, the camera control button is a push button that is by default in the disengaged condition, being depressible by the user to dispose it to the engaged condition. Upon release of the depressed camera control button, it automatically returns to the disengaged condition.

In other examples, the single-action input mechanism can instead be provided by, for example, a touch-sensitive button comprising a capacitive sensor mounted on the frame 832 adjacent to its surface for detecting the presence of a user's finger, to dispose the touch-sensitive button to the engaged condition when the user touches a finger to the corresponding spot on the outer surface 866 of the frame 832. It will be appreciated that the above-described camera control button and capacitive touch button are but two examples of a haptic input mechanism for single-action control of the camera 869, and that other examples may employ different single-action haptic control arrangements.

The computer 861 is configured to perform the methods described herein. In some examples, the computer 861 is coupled to one or more antennas for reception of signals from a GNSS and circuitry for processing the signals where the antennas and circuitry are housed in the glasses 800. In some examples, the computer 861 is coupled to one or more wireless antennas and circuitry for transmitting and receiving wireless signals where the antennas and circuitry are housed in the glasses 800. In some examples, there are multiple sets of antennas and circuitry housed in the glasses 800. In some examples, the antennas and circuitry are configured to operate in accordance with a communication protocol such as Bluetooth™, Low-energy Bluetooth™, IEEE 802, IEEE 802.11az/be, and so forth. In some examples, PDR sensors housed in glasses 800 and coupled to the computer 861. In some examples, the glasses 800 are VR headsets where optical elements 843, 844 are opaque screens for displaying images to a user of the VR headset. In some examples, the computer 861 is coupled to user interface elements such as slide or touchpad 876 and button 878. A long press of button 878 resets the glasses 800. The slide or touchpad 876 and button 878 are used for a user to provide input to the computer 861 and/or other electronic components of the glasses 800. The glasses 800 include one or more microphones 882 that are coupled to the computer 861. The glasses 800 include one or more gyroscopes 880.

### Augmented Reality Activated Dispensing Machine

FIG. 9 is a schematic diagram illustrating a system 900 for a dispensing machine 902, in accordance with some examples. The dispensing machine 902 is an apparatus that dispenses physical or virtual objects to a user 992. For example, the dispensing machine 902 may be a soda or soft drink vending machine where the user 992 often provides compensation via the compensation interface 911 such as monetary compensation in exchange for a vending item 925 such as candy, a soft drink, a t-shirt, an intangible item such as a non-fungible token (NFT), a ticket, cash, gift cards, or other vending items 925. The vending item 925 may be a code that is displayed on the display 908, which is then captured by the user 992.

The dispensing machine 902 may communicate with one or more other devices. For example, the dispensing machine 902 communicates directly or via the network 983 with backend A 974, backend B 978, and/or mobile device 982. The backend A 974 and/or backend B 978 may be servers such as interaction server system 110 of FIG. 1. The backend A 974 and/or backend B 978 may be a proprietary server associated with the dispensing machine 902. In some examples, one of the backend A 974 and backend B 978 is a server associated with the dispensing machine 902 and another one is a server associated with a social network system 222.

The mobile device 982 is a computing device 114, a head-wearable apparatus 116, or another mobile device associated with the user 992. The mobile device 982, backend A 974, and/or backend B 978 may perform one or more of the operations described herein.

The system 900 includes real-world scene 972, which is what the image capturing device 910 captures of the real world. The image capturing device 910 captures images 918 of the real-world scene 972 using an image capturing device 910 that captures the incident light 970.

The input/output (10) devices 904 includes devices that enable a user 992 to receive output or send input to the dispensing machine 902. The IO devices 640 include a clock 919, speaker 909, microphone 906, display 908, image capturing device 910, selection interface 912, and compensation interface 911. One or more of the IO devices 904 may not be included and the IO device 904 may include additional IO devices. In some examples, the IO devices 904 include a Lidar system or a similar system for detecting and mapping out objects such as the user 992 in the real-world scene 972. The sensors 916 includes a light sensor, a positioning sensor, and so forth.

The image capturing device 910 is a charged-coupled device (CCD) or another type of device to capture the image 918 of the real-world scene 972. The microphone 906 enables the user 992 to provide voice 996 input. The image capturing device 910 enables the user 992 to provide gesture 958 input via the UI module 954, where the body tracking module 952 processes or analyzes the images 918 to determine the gesture 958 and the user intent 964 based on the analysis of the images 918.

The selection interface 912 includes hardware that enables a user 992 to select a vending item 925 or an item 960. For example, a physical button on the dispensing machine 902 may select a soda, which may be mapped to an item 960 of a UI 962. The selection interface 912 may be a touchscreen, buttons, levers, knobs, and so forth. In some examples, there is no separate selection interface 912. The vending items 925 are selected by the user 992 based on user data 968, which is used to detect gestures 958 and the user intent 964 as described herein.

The compensation interface 911 includes hardware that enables the user 992 to pay for or compensate the dispensing machine 902 or an entity associated with the dispensing machine 902 for a vending item 925. The compensation interface 911 may take credit cards, paper cash, coins, electronic payment via the wireless module 928, and so forth. In some examples, the compensation interface 911 has a separate wireless module to perform electronic payments.

The body tracking module 952 determines a location 999 of the user 992. The location 999 includes an orientation of the head 995, eyes 994, hands 967, and other body parts of the user 992, in accordance with some examples. In some examples, the location 999 is in 3D coordinates within a 3D world coordinate system that indicates a location of the user view 998. In some examples, the location 999 is in 3D coordinates that is relative to an object or another location. The user view 998 is what the user 992 sees.

The wireless module 928 communicates via communications 959 between the backend A 974, backend B 978, and the mobile device 982. The communications 959 are direct or via one or more devices such as through the network 983. In some examples, the communications 959 are between the mobile device 982, the backend A 974, and/or the backend B 978. In some examples, the communications 959 are from the mobile device 982 through the dispensing machine 902 and then to the backend A 974 or backend B 978.

The wireless module 928 is configured to perform wireless communication protocols with the backend A 974, he backend B 978, and/or the mobile device 982. The communication protocols include LE Bluetooth, Institute for Electrical and Electronic Engineers (IEEE) 802.11 communication protocols, proprietary communications protocols, 3GPP communication protocols, and so forth. The wireless module 928 is in communication with hardware such as transceiver circuitry and antennas, which are part of the IO devices 904, to perform the wireless protocols. The wireless module 928 sets up a wireless communication link between the backend A 974, backend B 978, and/or the mobile device 982. For example, the wireless module 928 associates with a corresponding wireless module on the backend A 974, the backend B 978, or the mobile device 982. The wireless module 928 may communicate with the backend A 974, backend B 978, or mobile device 982 via intermediate devices such as a user system 102, which may also be the backend A 974 or backend B 978, an access point, a node B, and so forth.

In some examples, the wireless module 928 can be used to determine a location and/or an orientation of the dispensing machine 902 with the assistance of other wireless devices. The mobile device 982 may be local or close to the dispensing machine 902 and the dispensing machine 902 may communicate via BlueTooth Low Energy (BLER). In some examples, the dispensing machine 902 communicates with the mobile device 982 via a user system 102 such as a paired mobile phone. Wireless communications such as BLE® transmitted and received by the wireless module 928 can be used to determine a location and/or an orientation of the dispensing machine 902 so the wireless communication may also be considered a sensor 916. The dispensing machine 902 may determine a geographical location of the dispensing machine 902. The geographical location may be configured by a technician or software module.

The user data 968 is data that is related to the user 992. The user data 968 includes data that is generated by the IO devices 904 based on the user 992 such as the images 918 that include light reflecting off the user 992 and data from the microphone 906 generated from the voice 996 of the user 992. The input data 991 includes information provided by the user such as a user account and physical data such as light reflecting off the user and the sound waves from the voice 996 of the user 992. The information (info) 966 includes additional information about the user 992, which may have been collected about the user 992 or provided by the user 992, such as a social media account to log onto the interaction server system 110, a username, and so forth. The UI module 954 determines gestures 958 based on analyzing the user data 968 such as images 918 of the user 992 and data from the microphone 906 generated from the voice 996 of the user 992.

The UI module 954 determines the user intent 964 based on input from the user 992 based on haptic 993, eyes, 994, head 995, hand 967, voice 996, location 999, and so forth. The user intent 964 is a determination of an item 960 that the user 992 would like to select to have a function performed associated with the item 960. For example, the user 992 may press a virtual button displayed on the display 908 using an AR gesture 958 to select an item 960 from a menu of items 960 to perform the function of selecting a vending item 925.

The body tracking module 952 determines gestures 958 based on processing the user data 968 such as images 918 of the user 992 and data from the microphone 906 generated from the voice 996 of the user 992 to track the eyes 994, head 995, location 999, and voice 996 of the user 992 to determine if a gesture 958 was performed. For example, the user 992 may close their hand 967 around a displayed vending item 925 to indicate a gesture 958 of selecting the vending item 925. There may be more than one user 992. The user intent 964 in this example is to select the displayed vending item 925. The UI 962 is user interfaces such as a menu for functionality available to the user 992 to perform on the dispensing machine 902. The items 960 are the items of the UI 962. The UI 962 may not be displayed to the user as in the case where the user 992 selects a vending item 925 via a gesture 958. The body tracking module 952 may determine the location 999 of the user 992.

The operating system 920 manages the resources of the dispensing machine 902. The application execution module 922 is an interpreter that executes applications 924, in accordance with some examples. The applications 924 may include the dispensing machine module 949. The operating system 920 may use a cloud application programming interface (API) 923 to access remote API 985 on the backend A 974, backend B 978, and/or mobile device 982. The functions performed by the various modules on the dispensing machine 902 may be performed wholly or partially by the backend A 974, backend B 978, and/or mobile device 982. For example, the functions performed by the body tracking module 952 may be performed by the backend A 974. The images 918 may be transmitted to the backend A 974 and the backend A 974 may determine the user intent 964 and/or the location 999 of the user 992.

The 3D presentation module 989 presents on the display 908 and/or on the mobile device 982. The 3D presentation module 989 takes graphical images to render 943, the images 918, an avatar 951 of the user 992, and items 960, and generates rendered graphics 945, which are displayed on the display 908 and may include music or sounds that are played on the speaker 909. The 3D presentation module 989 provides an AR experience to the user by generating processed graphics 945 that appear to be 3D dimensional to the user 992. The graphics 945 are generated based on the location 999 of the user 992, which the body tracking module 952 determines, so that the processed graphics 945 appear to be 3D dimensional. Additionally, the avatar 951 of the user 992, which may be an image of the user 992, may be resized to appear to be within a 3D dimensional world generated by the 3D presentation module 989. Additionally, the avatar 951 of the user 992 may include many effects that process the image of the user 992. For example, applications 924 may be used that make the user 992 appear older, younger, as a type of animal, and so forth. The processed graphics 945 may include images of the vending item 925, the output of games, which may be applications 924, UIs 962, and so forth.

The content items 943 are graphics that are to be displayed. The content items 943 may not need to be rendered but only displayed, which may be include placement, resizing, and color adjustments. The content items may include images, videos, 3D objects, and so forth. The content items 943 may be a mathematical coordinate-based representation of surfaces of objects in three dimensions. The content items may be based on polygons. The content items may be streamed content such as a movie. The content items 943 may need to be rendered by prior to being displayed. The content items 943 may be animated. The displaying of the content item 943 may require repeatedly re-displaying the content item 943 an appropriate times per second because the content of the content item 943 may change and the position of the user 992 may change. For example, the 3D presentation module 989 generates a frame 977 that is displayed on the display 908 multiple times a second. The 3D presentation module 989 may have to re-render content items 943 and/or move the content items 943 because the location 999 of the user 992 has changed. In some examples, the application 924 may control the frame 977 generation. For example, the application 924 may be a game that sends content items 943 to the 3D presentation module 989. In some examples, the 3D presentation module 989 transmits rendered graphics 945 or other items for the mobile device 982 to display on a display of the mobile device 982 where the display by be an AR, MR, or VR display of a head-wearable apparatus 116 or may be a display of a computing device 114.

The rendering module 957 renders content items 943 that need to be rendered to generate processed graphics 945. The rendering module 957 may adjust processed graphics 945 in accordance with movement of the user 992. The frame 977 may be configured to make the processed graphics 945 appear 3D to the naked eyes 994 of the user 992. To maintain the illusion that the processed graphics 945 are 3D the processed graphics 945 may need minor adjustments between frames 977 to account for the location 999 of the user 992. The avatar 951 is a representation of the user 992, which may take many forms.

The rendering module 957 may process the content items 943 such as indications of the vending items 925 based on a location of the user 992 in order to generate graphics that appear to be 3D to the user 992. The 3D presentation module 989 may monitor the location 999 of the user 992 and adjust the processed graphics 945 if the user 992 changes the location 999 or have the rendering module 957 re-process or re-render the processed graphics 945 for the new location 999 of the user 992.

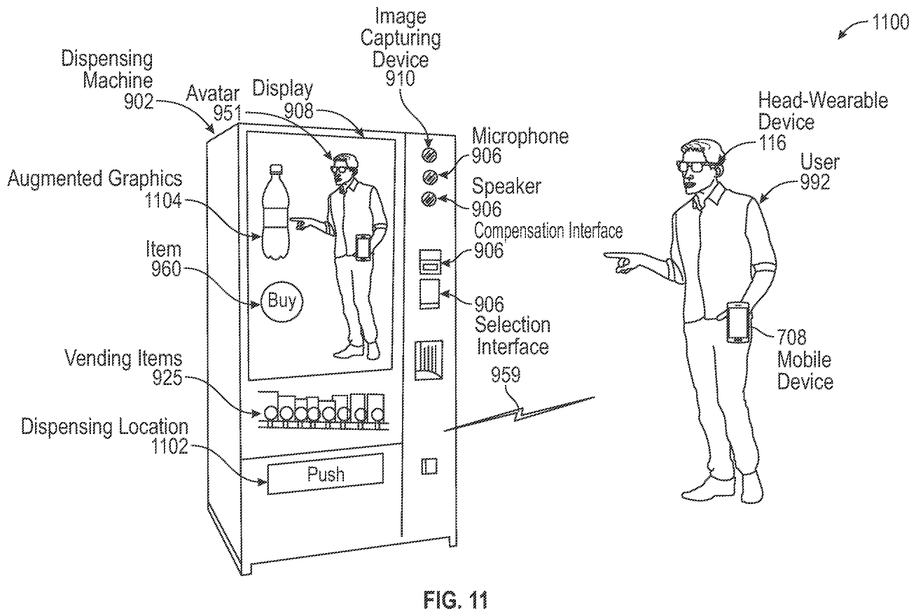

The detection module 984 detects if a user 992 should be attended to by the dispensing machine 902. For example, the dispensing machine 902 may be in a hall and the detection module 984 may determine to ignore most users 992 until a user 992 pauses in front of the dispensing machine 902. The events 987 may be functions that are to be performed based on the user intent 964. For example, an event 987 may be the selection of an item 960 that indicates that the user 992 would like a vending item 925. The function associated with the event 987 may be to provide the vending item 925 to the user 992 via a dispensing location 1102 (FIG. 11) or via the display 908. The security module 953 ensures that the user 992 is a verified user for using the compensation interface 911 and ensures that personal data is not stored for privacy reasons.

The dispensing machine modules 976 are functions or modules that are available on the backend A 974 to the mobile device 982, backend B 978, and/or the dispensing machine 902. In some examples, the functions or module of the dispensing machine module 976 are accessed using the remote API 985. The dispensing machine modules 980 are functions or modules that are available on the backend B 978 to the mobile device 982, backend A 974, and/or the dispensing machine 902. In some examples, the functions or modules of the dispensing machine module 976 are accessed using the remote API 985. The dispensing machine modules 986 are functions or modules that are available on the backend A 974 to the backend B 978 and/or the dispensing machine 902. In some examples, the functions or module of the dispensing machine module 976 are accessed using the remote API 985.

FIG. 10 is a schematic diagram illustrating a system 1000 for a dispensing machine 902, in accordance with some examples. The mobile device 982 and head-wearable apparatus 116, communicate by sending communications 959 to one another, the dispensing machine 902, backend A 974, backend B 978, or another device. The network 983 is a cellular telephone network such as an LTE network, an IEEE 802.11 network, a BLUETOOTH® network, private network, or another wireless network using another wireless communication protocol. The network 983 may include access to the internet. The associated application 1002 is an application that is associated with the dispensing machine 902. For example, the associated application 1002 may provide items 960 that can be selected or enable frames 977 to be displayed on a display of the head-wearable apparatus 116 and/or the mobile device 982.

In some examples, the backend A 974 and/or backend B 978 provide a social networking service, to enable communication of content such as photos, videos, status updates, media content messages, and the like, directly to social-media entities, platforms, or applications such as Snapchat® from the mobile device 982, head-wearable apparatus 116, and/or the dispensing machine 902. In some examples, the backend A 974 and/or backend B 978 is an interaction server system 110 and the frames 977 and/or images 918 are broadcasted or otherwise communicated via a network 983, which may be in near-real time, to another device as mobile device 982, to backend A 974, backend B 978, another dispensing machine 902, or another device.

FIG. 11 is a schematic diagram illustrating a system 1 100 for a dispensing machine 902, in accordance with some examples. The user 992 is standing in front of the dispensing machine 902. The dispensing machine 902 captures images 918 using the image capturing device 910. The 3D presentation module 989 uses the images 918, content items 943, items 960, and/or the avatar 951 to generate frames 977 that are displayed on the display 908.

The user interface item 960, augmented graphics 1104, and the avatar 951 of the user 992 are being displayed on the display 908 by the dispensing machine 902. The UI module 954 will determine the user interface item 960 was selected by the user 992 if the user 992 moves his hand 967 so that the hand of the avatar 951 is at the same location as the user interface item 960 and the hand of the avatar 951 is held at the same location for a threshold period of time. The augmented graphics 1104 is a content item 943 that the rendering module 957 rendered based on the location 999 of the user 992 into processed graphics 945 to appear to be 3D.

The vending items 925 after being selected and paid for are dispensed by the dispensing machine 902 at the dispensing location 1102. In some examples, the dispensing machine 902 sends or receives via communication 959 commands to the mobile device 982 and/or wearable device 719. In some examples, the vending items 925 are printed on a printer 927. For example, a ticket for a movie, an airline reservation, and so forth. The commands may include the functions described in conjunction with the operation of dispensing machine 902. For example, the dispensing machine 902 may send the frame 977 to the head-wearable apparatus 116 to display. In some examples, the security module 953 sends confidential information or non-tangible vending items 925 to the head-wearable apparatus 116 or the mobile device 982. In some examples, the user 992 may enter payment information via the head-wearable apparatus 116 and/or the mobile device 982 and the security module 953 will ensure that the confidential information was transmitted securely over communication 959.

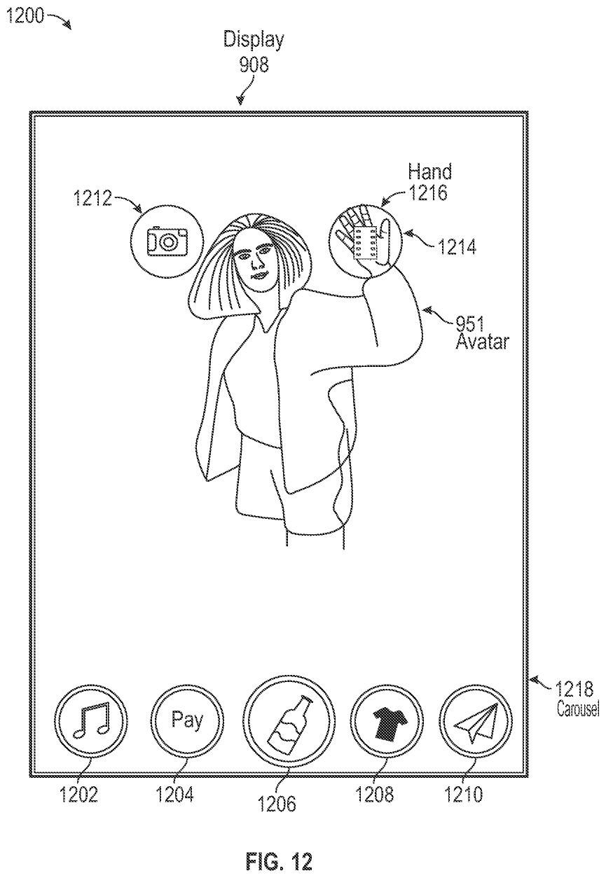

FIG. 12 is a schematic diagram illustrating a system 1200 for a dispensing machine, in accordance with some examples. The user 992 (not illustrated) is standing in front of the dispensing machine 902 as illustrated in FIG. 11. The dispensing machine 902 captures images 918 using the image capturing device 910. The 3D presentation module 989 uses the images 918, content items 943, items 960, and/or the avatar 951 to generate frames 977 that are displayed on the display 908. The 3D presentation module 989 is displaying an avatar 951, which includes the hand 1216 of the avatar 951, and user interface items 960 that include icon 1202, icon 1204, icon 1206, icon 1208, icon 1210, icon 1212, and icon 1214. The user 992 selects a user interface item 960 by moving their body to cause the hand 1216 of their avatar 951 to remain over a user interface item 960 for a threshold period of time. Here, icon 1214 is being selected that indicates the user 992 would like to record a video. The UI module 954 identifies the gesture 958 of keeping the hand 1216 over (or hovering over) the user interface item 960 of the icon 1214 and determines the user intent 964 is to select the icon 1214, which has an associated action of running an application 924 for recording a video of the user 992.

Creating the video may be free to the user 992, which may encourage interaction with the dispensing machine 902 and may increase sales. Selection of icon 1202 means to run an application 924 to create a music video. Selection of icon 1204 means to run an application 924 to assist the user 992 in paying for a vending item 925, which may have associated costs, which may be monetary, bonus points, and so forth. Selection of icon 1206 means to run an application 924 to provide vending services for a drink or another vending item 925. Selection of icon 1208 means to run an application 924 to provide vending services for merchandise, which may or may not be physically present in the dispensing machine 902. Selection of icon 1210 indicates to send a photograph, video, vending item 925, compensation, so another item to a location different than the dispensing machine 902 such as on the backend A 974, backend B 978, mobile device 982, or another location. Selection of icon 1212 means to run an application 924 to provide photography services for the user 992. The icons 1202, 1204, 1206, 1208, and 1210 are part of a carousel 1218. In some examples, the user 992 can scroll the carousel 1218 to find other user interface items 960 that the user 992 may select.

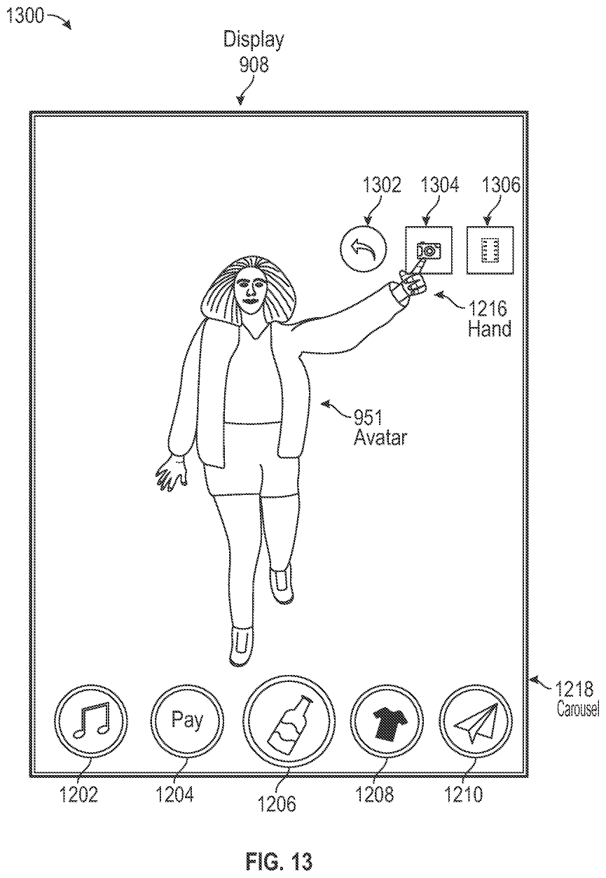

FIG. 13 is a schematic diagram illustrating a system 1300 for a dispensing machine, in accordance with some examples. The user 992 (not illustrated) is standing in front of the dispensing machine 902 as illustrated in FIG. 11. The dispensing machine 902 captures images 918 using the image capturing device 910. The 3D presentation module 989 uses the images 918, content items 943, items 960, and/or the avatar 951 to generate frames 977 that are displayed on the display 908. The 3D presentation module 989 is displaying an avatar 951, which include the hand 1216 of the avatar 951, and user interface items 960 that include icon 1202, icon 1204, icon 1206, icon 1208, icon 1210, icon 1302, icon 1304, and icon 1306. The user 992 selects a user interface item 960 by pointing at the user interface item 960. Here, icon 1304 is being selected that indicates the user 992 would like to take a picture. The UI module 954 analyzes the images 918 to determine that the gesture 958 of pointing is pointing at a user interface item 960 of icon 1304 for a threshold duration.

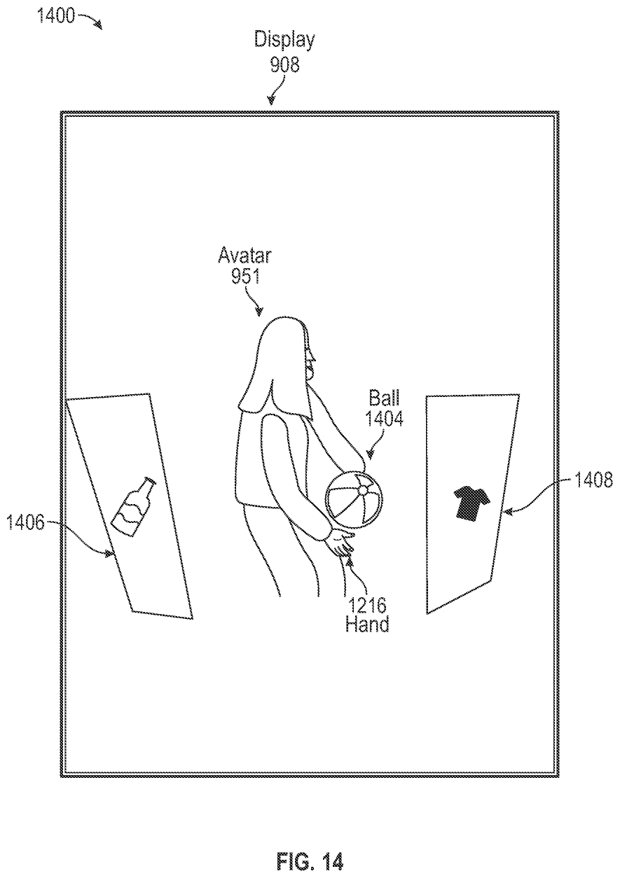

FIG. 14 is a schematic diagram illustrating a system 1400 for a dispensing machine, in accordance with some examples. The user 992 (not illustrated) is standing in front of the dispensing machine 902 as illustrated in FIG. 11. The dispensing machine 902 captures images 918 using the image capturing device 910. The 3D presentation module 989 uses the images 918, content items 943, items 960, and/or the avatar 951 to generate frames 977 that are displayed on the display 908. The 3D presentation module 989 is displaying an avatar 951, which includes the hand 1216 of the avatar 951, and user interface items 960 that include ball 1404, icon 1406, and icon 1408. The user 992 grasps the virtual ball 1404 by the gesture 958 of putting their hands around or near the ball 1404. The UI module 954 determines the user intent 964 is to grasp the ball 1404, which may active an application 924 to move the ball 1404 with the hands 1216 of the avatar 951. The user 992 can then select icon 1406 or icon 1306 by throwing or moving the ball 1404 through the rectangle that is part of icon 1406 and icon 1408.

The UI module 954 analyzes the images 918 to determine that the gesture 958 of putting or throwing the ball 1404 through icon 1406 or icon 1408 selects the corresponding icon. The UI module 954 then invokes the appropriate application 924 for the selected icon.

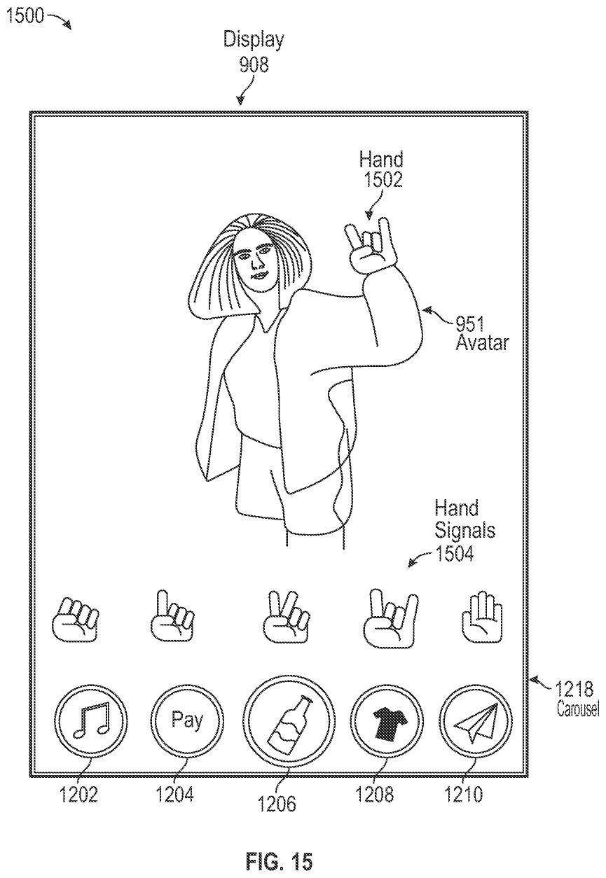

FIG. 15 is a schematic diagram illustrating a system 1500 for a dispensing machine, in accordance with some examples. The user 992 (not illustrated) is standing in front of the dispensing machine 902 as illustrated in FIG. 11. The dispensing machine 902 captures images 918 using the image capturing device 910. The 3D presentation module 989 uses the images 918, content items 943, items 960, and/or the avatar 951 to generate frames 977 that are displayed on the display 908.

The 3D presentation module 989 is displaying an avatar 951, which includes the hand 1502 of the avatar 951, and user interface items 960. The UI module 954 displays hand signals 1504 above corresponding icons 1202, 1204, 1206, 1208, and 1210. The hand signals 1504 indicate to the user 992 how to select an icon 1202, 1204, 1206, 1208, and 1210. Here, the hand 1502 is indicating to select icon 1208.

The UI module 954 identifies the hand signals 1504 as gestures 958 that select items 960, which are associated with modules, functions, or application 924 that are to be invoked upon the selection of the item 960. The UI module 954 may change the image of the hand 1502 of the avatar 951 if the UI module 954 determines above a threshold that the user 992 may be trying to form the hand signal 1504 for a threshold period of time. For example, the user 992 may make a hand signal 1504 that appears to be hand signal 1504 corresponding to icon 1208 but to be sure that the user 992 intends to make this hand signal 1504 the UI module 954 changes the image of the hand 1502 to more clearly be the hand signal 1504, which may include creating a cartoonish or exaggerated hand signal 1504 to indicate to the user 992 that the user 992 is selecting this particular hand signal 1504.

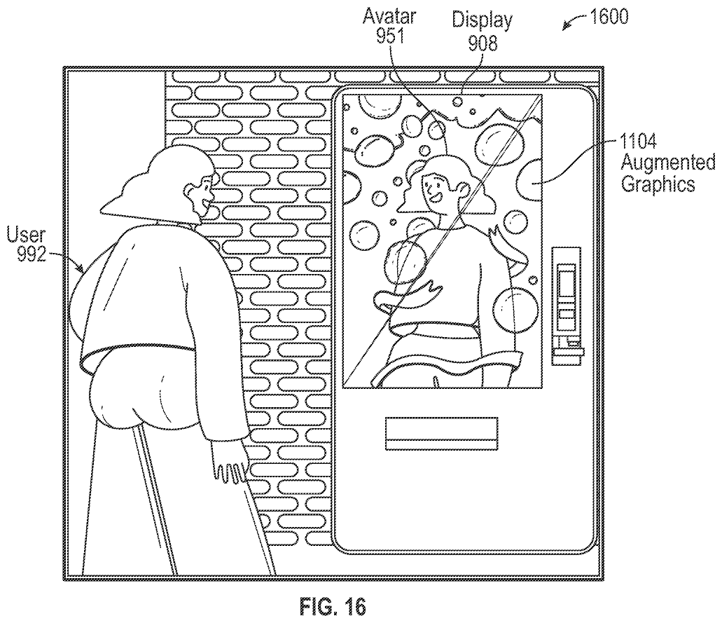

FIG. 16 is a schematic diagram illustrating a system 1600 for a dispensing machine, in accordance with some examples. The user 992 is standing in front of the dispensing machine 902. The dispensing machine 902 captures images 918 using the image capturing device 910. The 3D presentation module 989 uses the images 918, content items 943, items 960, and/or the avatar 951 to generate frames 977 that are displayed on the display 908. Here, the 3D presentation module 989 is displaying engaging augmented graphics 1104 and an avatar 951 that may be modified or an idealized image of the user 992. For example, the avatar 951 may have a party hat, party clothes, image processing to improve the complexion of the user 992, and so forth.

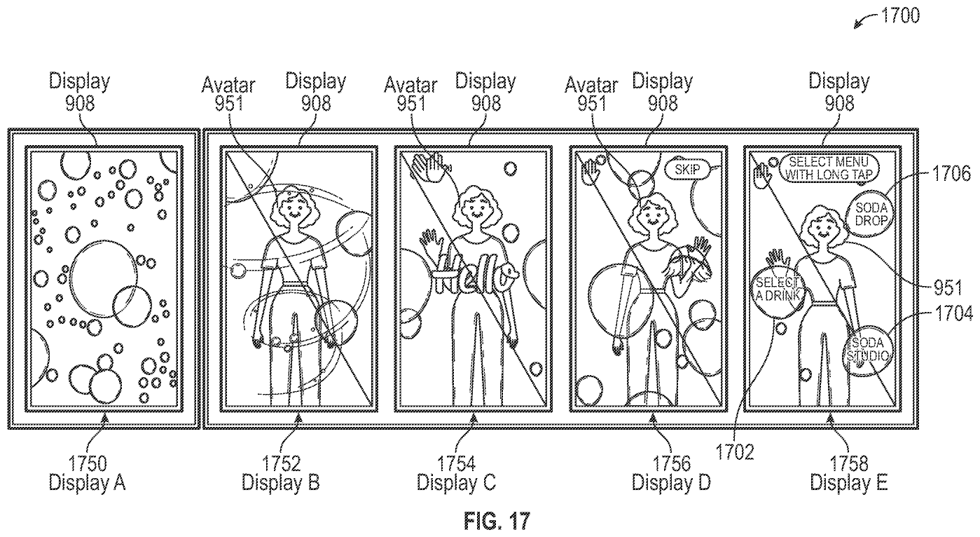

FIG. 17 is a schematic diagram illustrating a system 1700 for a dispensing machine, in accordance with some examples. A series of displays 908 is illustrated. Display A 1750 illustrates the display 908 of the dispensing machine 902 while it is idle or waiting for a user 992. Display B 1752 illustrates that the detection module 984 detected a user 992 and the 3D presentation module 989 processed the images 918 to generate an avatar 951 of the user 992. The 3D presentation module 989 may add warm inviting colors to the frames 977 that are displayed on the display 908. In display C 1754, the 3D presentation module 989 welcomes the user 992 with a greeting of “Hello”. The avatar 951 may start off as a realistic image of the user 992 and progress to being processed. In display D 1756, the 3D presentation module 989 has added additional processed graphics 945 to make it appear that the user 992 is in a 3D world. In display E 1758, a menu with three options appears. The options are based on icons 1702 “select a drink”, icon 1704 “soda studio”, and icon 1706 “soda drop.”

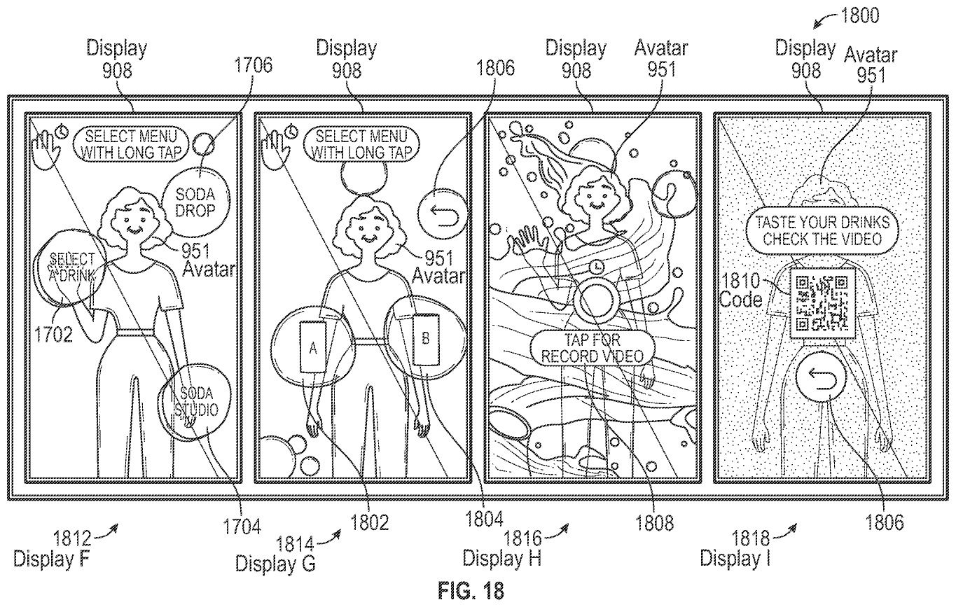

FIG. 18 is a schematic diagram illustrating a system 1800 for a dispensing machine, in accordance with some examples. The series of displays 908 from FIG. 17 is continued. In display F 1812 the user 992 selects icon 1702 to “select a drink”. The 3D presentation module 989 indicates that to select an item 960 of a menu the user 992 is to “select menu with a long tap.” Here the items 960 are sub-menus.

In display G 1814, the icon 1802 for drink “A” and icon 1804 for drink “B” are displayed within bubbles. Additionally, a return to previous menu icon 1806 is displayed. The 3D presentation module 989 displays animations (not illustrated) and additional product information to induce the user 992 to purchase the drink and to educate the user 992 about the drinks. In display H 1816, the user 992 has selected drink “A” 1804 and the dispensing machine 902 is dispensing the vending item 925 out of the dispensing location 1102. The 3D presentation module 989 generates frames 977 to provide an AR experience for the user 992. There may be a varied number of applications 924 to provide the AR experience and the AR experience may be selected based on characteristics of the user 992 and a location of the dispensing machine 902. For example, if the dispensing machine 902 is outside a music forum and the user 992 appears to have attended a music event, then an application 924 may provide an AR experience that includes the music played or about to played and other associated items. Icon 1808 provide the user 992 with the opportunity to record the AR experience. In display I 1818, the AR experience has ended and the user 992 is provided with a code 1810 to access the video. The video may be encrypted for privacy and the code 1810 may be sent to a mobile device 982 of the user 992 and/or a social media account of the user 992, an email account, and so forth.

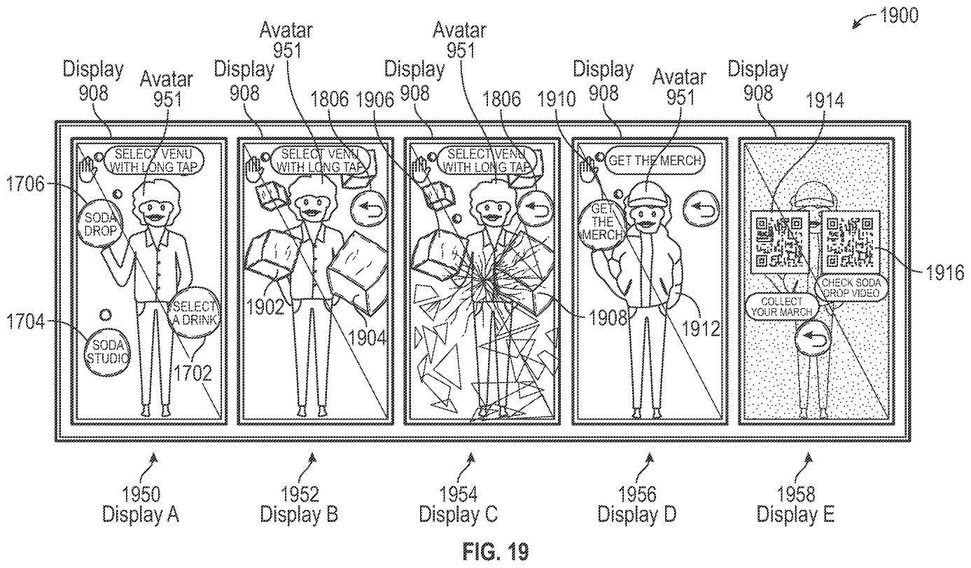

FIG. 19 is a schematic diagram illustrating a system 1900 for a dispensing machine, in accordance with some examples. The series of displays 908 may be preceded by displays 908 that are the same or similar to display A 1750, display B 1752, display C 1754, and display D 1756, with the avatar 951 of the user 992 illustrated in FIG. 19.

In display A 1950, the user 992 selects icon 1706 to “soda drop” with a gesture 958 of a “long tap.” The 3D presentation module 989 indicates that to select an item 960 of a menu of item 960 the user 992 is to “select menu with a long tap.” After the user 992 selects the “soda drop” 1706, the icons 1702, 1704, 1706, fly away and ice cubes cascade onto the display 908 each indicating a digital surprise or merchandise that the user 992 may obtain. In display B 1952, ice cubes such as ice cube 1902 and ice cube 1904 are flowing down the display 908 or moving in a different manner. The user 992 may scroll the ice cubes which are icons and items 960. In display C 1954, the user 992 selects ice cube 1908 which opens up to display merchandise that the user 992 may obtain. Ice cube 1906 indicated different merchandise.

In display D 1956, the avatar 951 now displays the user 992 wearing the merchandise, which is a jacket 1912. An application 924 may be used by the 3D presentation module 989 for virtually trying on the merchandise such as the jacket 1912 as illustrated. The item 960 icon 1910 with the label “Get the Merchandise” is displayed to offer the user 992 the opportunity to obtain the merchandise.

In display E 1958, the user 992 has selected icon 1910 to “Get the Merch”. The 3D presentation module 989 displays a code 1916 for the user 992 to get a video of the avatar 951 with the jacket and a code 1914 for the user 992 to obtain the merchandise. In some examples, the dispensing machine 902 vends the vending item 925 such as the merchandise may be inside a soda bottle or can. Or the dispensing machine 902 may be configured to vend items such as jackets. In some examples, the user 992 pays for the vending item 925. In some examples, the code 1914 brings the user 992 to a webpage of a website for the user 992 to order the merchandise such as from an online webstore. The code 1914 or code 1916 may be sent to mobile device 982 and the security module 953 may assist the user 992 in providing compensation for the merchandise. In some examples, the user 992 may win merchandise by playing a game, redeeming reward points, or in another way. For example, the user 992 may purchase a soda and the soda may have code to indicate whether the user 992 won another soda or merchandise or the soda may indicate a number of reward points, which may be vended to the user 992 electronically.

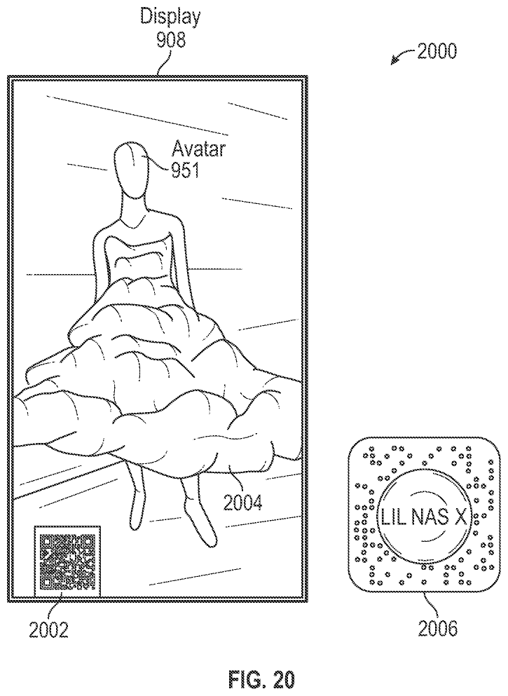

FIG. 20 is a schematic diagram illustrating a system 2000 for a dispensing machine, in accordance with some examples. The user 992 (not illustrated) is standing in front of the dispensing machine 902 as illustrated in FIG. 11. The dispensing machine 902 captures images 918 using the image capturing device 910. The 3D presentation module 989 uses the images 918, content items 943, items 960, and/or the avatar 951 to generate frames 977 that are displayed on the display 908. The user 992 selected code 2006 or provided code 2006, which indicates an application 924 to virtually wear the dress 2004 and provide additional AR graphics. The user 992 may take a picture or video and may be provided with code 2002 to access the picture or video as described herein. In some examples, the code 2006 is displayed on the mobile device 982 and the detection module 984 detects the code and the dispensing machine module 949 retrieves locally or remotely an application 924 for providing AR effects for virtually trying on the dress 2004. In some examples, an option to purchase or obtain the dress is offered.

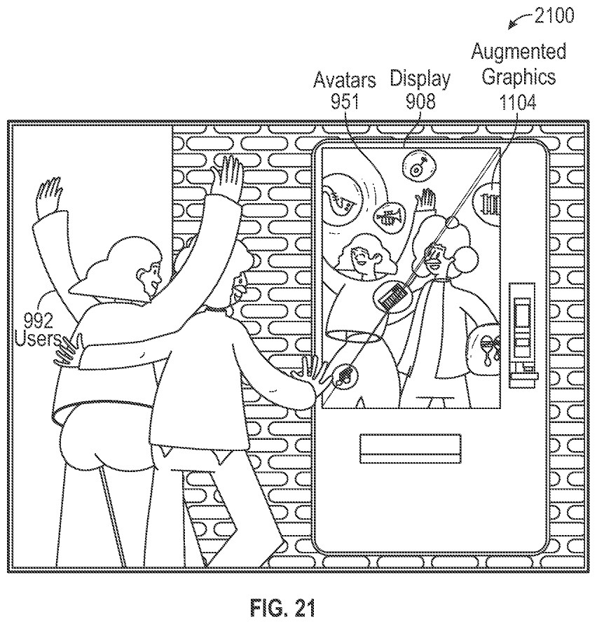

FIG. 21 is a schematic diagram illustrating a system 2100 for a dispensing machine, in accordance with some examples. The users 992 are standing in front of the dispensing machine 902. The dispensing machine 902 captures images 918 using the image capturing device 910. The 3D presentation module 989 uses the images 918, content items 943, items 960, and/or the avatars 951 to generate frames 977 that are displayed on the display 908. Here, the 3D presentation module 989 is displaying engaging augmented graphics 1104 and avatars 951 that may be modified or an idealized images of the users 992. For example, the avatars 951 may have a party hat, party clothes, image processing to improve the complexion of the users 992, and so forth. The AR experience provided indicates a studio for the users 992 to create a music video.

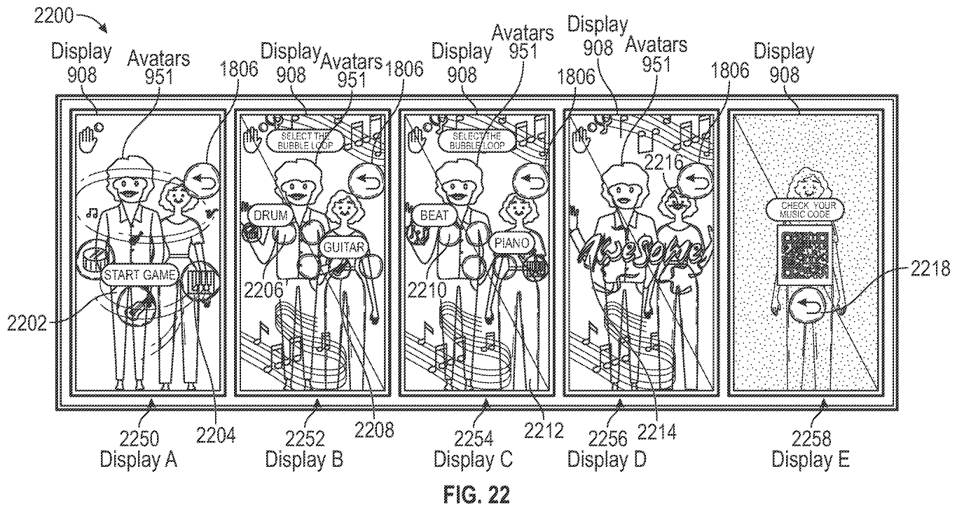

FIG. 22 is a schematic diagram illustrating a system 2200 for a dispensing machine, in accordance with some examples. The users 992 are standing in front of the dispensing machine 902. The dispensing machine 902 captures images 918 using the image capturing device 910. The 3D presentation module 989 uses the images 918, content items 943, items 960, and/or the avatars 951 to generate frames 977 that are displayed on the display 908.

In display A 2250 the users 992 have selected “Soda Studio” 1704 of FIG. 17. The 3D presentation module 989 is displaying engaging augmented graphics 1104 and avatars 951 that indicate that the users 992 may create a music video, play a game, or play music. For example, a keyboard 2204 is displayed within a bubble. Icon 2202 with label “Start Game” is an item 960.

In display B 2252, floating musical bubble with instruments inside appear as the menu icon 2202 flies away. The musical bubbles include icon 2206 with a “drum” and icon 2208 with a “guitar.” In display C 2254, the users 992 create a magical beat by selecting the bubbles and creating a tune. Icon 2210 a bubble with a “Best” and icon 2212 with a “Piano” may be selected by a gesture 958 as disclosed herein.

In some examples, there are multiple bubbles such as six to eight bubbles, or another number, with instruments. The bubbles float around the avatars 951. The users 992 interact with the musical instruments within the bubbles with gestures 958. For example, a user 992 can grab and pinch a bubble to play the musical instrument. The volume or pitch may be adjusted with gestures 958. In some examples, there are beat bubbles that can set beats.

The dispensing machine module 949 or an application 924 records the video and the music that was generated. In display D 2256, the users 992 have finished their music video and the dispensing machine module 949 or an application 924 replays the music video. In some examples, a face swap filter was used during the music video or after the music video was completed to exchange the faces of the avatars 951 such as the mustache 2216 on the female avatar 951. The users 992 may have selected to use the face swap filter or the dispensing machine module 949 or an application 924 may have determined to use the face swap filter. The dispensing machine module 949 or an application 924 may add titles or other graphics such as “Awesome” 2214. In display E 2258, the users 992 are offered a code 2218 as disclosed herein to retrieve the music video they created.

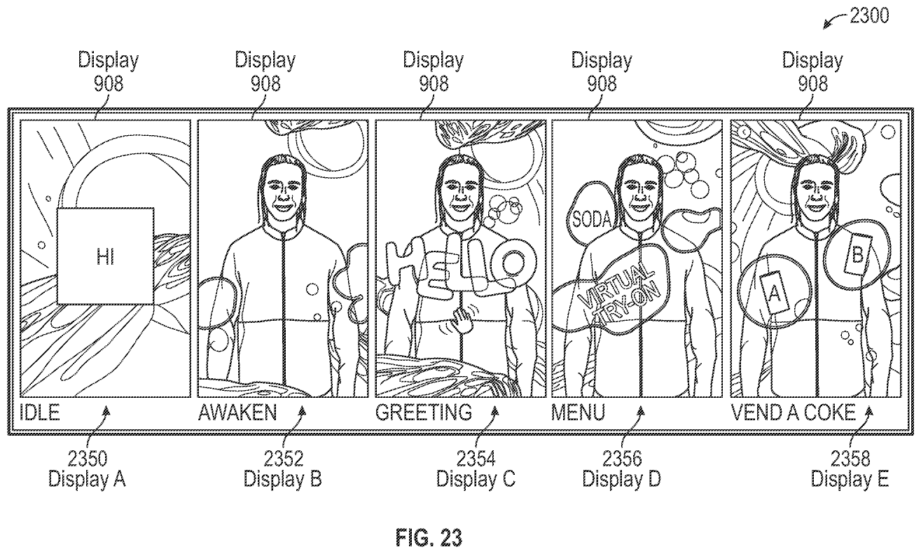

FIG. 23 is a schematic diagram illustrating a system 2300 for a dispensing machine, in accordance with some examples. The user 992 is standing in front of the dispensing machine 902. The dispensing machine 902 captures images 918 using the image capturing device 910. The 3D presentation module 989 uses the images 918, content items 943, items 960, and/or the avatars 951 to generate frames 977 that are displayed on the display 908.

Display A 2350 illustrates an idle state. Display B 2352 illustrates a wake-up state where the detection module 984 has detected the user 992 and the 3D presentation module 989 is processing he images 918 to generate the avatar 951, which may be merely the image 918 of the user 992. Display C 2354 illustrates a “Hello” screen with a message that the user 992 should “Wave to get started”. Display D 2356 illustrates a display 908 after the user 992 has waved to get started. Items 960 are being displayed such as “virtual try-on”, “grab a soda”, and “play a game.” Other options or different options may be provided. Display E 2358 illustrates where the user 992 has selected the “grab a soda” option and there are two sodas, soda “A” and soda “B” available for the user to select 992.

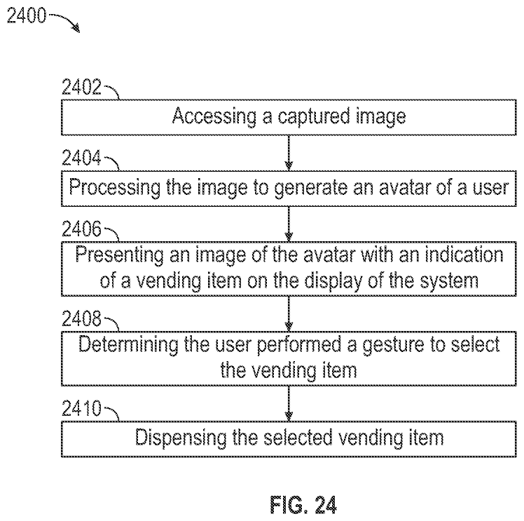

FIG. 24 illustrates a method 2400 for augmented reality activated dispensing machines, in accordance with some examples. The method 2400 begins at operation 2402 with accessing a captured image. For example, the dispensing machine 902 of FIG. 9 may access an image 918 captured by the image capturing device 910. The method 2400 continues at operation 2404 with processing the image to generate an avatar of a user. For example, the 3D presentation module 989 may determine an avatar 951 for the user 992. The user 992 may indicate or supply an avatar 951 to use via their mobile device 982 or using the interfaces provided by the UI module 954.

The method 2400 continues at operation 2406 with presenting an image of the avatar with an indication of a vending item on the display of the system. For example, the augmented graphics 1104 of FIG. 11 is a vending item 925 and the avatar 951 is an avatar of the user 992.

The method 2400 continues at operation 2408 with determining the user performed a gesture to select the vending item. For example, FIGS. 12-15 disclose example gestures 958 that may be recognized by the UI module 954. The method 2400 continues at operation 2410 with dispensing the selected vending item. For example, the dispensing machine 902 may provide a vending item 925 by dispensing a physical object, printing a vending item 925, or provide a code to the user 992.

The method 2400 may optionally include one or more additional operations. The operations of method 2400 may be performed in a different order. One or more of the operations of method 2400 may be optional. The method 2400 may be performed by an apparatus of a dispensing machine 902, a mobile device 982, backend A 974, and/or backend B 978.

### CONCLUSION

The dispensing machine 902 enables display of many different vending items 925 and enables the dispensing machine 902 to provide 3D images of the vending items 925, which enables the user 992 to better understand the vending items 925. Additionally, the dispensing machine 902 may perform virtual try on by showing the user what the user would look like wearing the vending items 925.

### EXAMPLES

Example 1 is a system comprising: a display; at least one processor coupled to the display; at least one memory component storing instructions that, when executed by the at least one processor, cause the at least one processor to perform operations comprising: accessing a captured image; processing the image to generate an avatar of a user; presenting an image of the avatar with an indication of a vending item on the display of the system; determining the user performed a gesture to select the vending item; and dispensing the selected vending item.

In Example 2, the subject matter of Example 1 includes, wherein system further comprises: an image capturing device coupled to the at least one processor; and wherein the operations further comprise: capturing the captured image using the image capturing device; and processing the captured image to detect the user.

In Example 3, the subject matter of Example 2 includes, wherein the operations further comprise: displaying on the display an indication that the user is to perform a gesture to view a menu of options provided by the system.

In Example 4, the subject matter of Examples 1-3 includes, wherein the processing the image to generate the avatar of the user comprises: sending the image to a computing device; and receiving an indication of a location of the user and an indication of the avatar.

In Example 5, the subject matter of Examples 1-4 includes, wherein the gesture is one of: causing a hand of the avatar to hover on the indication of the vending item, causing a finger of the avatar to point to the indication of the vending item, causing a virtual physical object to be pushed or throw through the indication of the vending item, and causing the hand of the avatar to form a hand signal, the hand signal corresponding to the vending item.

In Example 6, the subject matter of Examples 1-5 includes, wherein the operations further comprise: generating a video of the user, wherein the video generated is based on the vending item; and providing the user with a code for the user to access the video.

In Example 7, the subject matter of Examples 1-6 includes, wherein the gesture is a first gesture, the vending item is a first vending item, and wherein the operations further comprise: displaying indications of a plurality of vending times on the display, the plurality of vending items comprising clothing; and in response to the user performing a second gesture, the second gesture indicating a second vending item, displaying on the display the avatar virtually wearing the second vending item.

In Example 8, the subject matter of Example 7 includes, wherein the operations further comprise: providing a code to the user, the code indicating a website for the user to obtain the second vending item.

In Example 9, the subject matter of Example 8 includes, wherein the providing comprises: sending the code to a mobile device of the user, sending the code to an email address of the user, or sending the code to a social media account of the user.

In Example 10, the subject matter of Examples 1-9 includes, wherein the indication of the vending item is displayed to appear to three-dimensional to the user, and wherein the indication of the vending item is generated based on a location of the user relative to the display of the system, and wherein the operation further comprises: adjusting the indication of the vending item based on the user moving to a new location.

In Example 11, the subject matter of Examples 1-10 includes, wherein the system is a vending machine and wherein the dispensing the selected vending item comprises one of: displaying a code on the display, sending the code to a computing device associated with the user, dispensing a physical device from the vending machine, and printing the vending item on a printer of the system.

In Example 12, the subject matter of Examples 1-11 includes, wherein the avatar is an image of the user, an avatar associated with the user, or an avatar selected by the system.

In Example 13, the subject matter of Examples 1-12 includes, wherein the operations further comprise: processing the image to generate a frame comprising the avatar and additional graphics, wherein the processing is based on an application selected by user or provided by the user.

In Example 14, the subject matter of Examples 1-13 includes, wherein the processing the image further comprises: determining a location of the user relative to the system ; and generating graphics of the vending item to appear three-dimensional (3D) based on the location of the user.

In Example 15, the subject matter of Examples 1-14 includes, wherein the operations further comprise: processing the image to generate the avatar and to generate augmented reality (AR) graphics of the vending item; and sending, for display, the processed image to a wearable AR device of the user.

In Example 16, the subject matter of Examples 1-15 includes, wherein the gesture is a first gesture and wherein the operations further comprise: displaying on the display the avatar and indications of musical instruments; in response to a second gesture to play a musical instrument of the musical instruments, generate and play on a speaker of the system music corresponding to the musical instrument; recording the display and sounds from the speaker to generate a musical video; and provide to the user a code to access the musical video.

Example 17 is a method comprising: accessing a captured image; processing the image to generate an avatar of a user; presenting an image of the avatar with an indication of a vending item on a display of a system; determining the user performed a gesture to select the vending item; and dispensing the selected vending item.

In Example 18, the subject matter of Example 17 includes, wherein the method further comprises: capturing the captured image using an image capturing device; and processing the captured image to detect the user.

Example 19 is a non-transitory computer-readable storage medium storing instructions that, when executed by at least one processor, cause the at least one processor to perform operations comprising: accessing a captured image; processing the image to generate an avatar of a user; presenting an image of the avatar with an indication of a vending item on a display of a system; determining the user performed a gesture to select the vending item; and dispensing the selected vending item.

In Example 20, the subject matter of Example 19 includes, wherein the operations further comprises: capturing the captured image using an image capturing device; and processing the captured image to detect the user.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

### GLOSSARY

“Carrier signal” refers, for example, to any intangible medium that is capable of storing, encoding, or carrying instructions for execution by the machine and includes digital or analog communications signals or other intangible media to facilitate communication of such instructions. Instructions may be transmitted or received over a network using a transmission medium via a network interface device.

“Client device” refers, for example, to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Communication network” refers, for example, to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers, for example, to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component”(or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” refers, for example, to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Ephemeral message” refers, for example, to a message that is accessible for a time-limited duration. An ephemeral message may be a text, an image, a video and the like. The access time for the ephemeral message may be set by the message sender. Alternatively, the access time may be a default setting or a setting specified by the recipient. Regardless of the setting technique, the message is transitory.

“Machine storage medium” refers, for example, to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” refers, for example, to a tangible medium that is capable of storing, encoding, or carrying the instructions for execution by a machine.

“Signal medium” refers, for example, to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

“User device” refers, for example, to a device accessed, controlled or owned by a user and with which the user interacts perform an action or interaction on the user device, including an interaction with other users or computer systems.

What is claimed is:

1. A system comprising:
a display;
at least one processor coupled to the display;
at least one memory component storing instructions that, when executed by the at least one processor, cause the at least one processor to perform operations comprising:
accessing a captured image;
processing the captured image to generate an avatar of a user;
presenting an image of the avatar with an indication of a vending item on the display of the system;
determining the user performed a gesture to select the vending item; and
dispensing the selected vending item.

2. The system of claim 1, wherein system further comprises:
an image capturing device coupled to the at least one processor; and wherein the operations further comprise:
capturing the captured image using the image capturing device; and
processing the captured image to detect the user.

3. The system of claim 2, wherein the operations further comprise:
displaying on the display an indication that the user is to perform a gesture to view a menu of options provided by the system.

4. The system of claim 1, wherein the processing the captured image to generate the avatar of the user comprises:
sending the image to a computing device; and
receiving an indication of a location of the user and an indication of the avatar.

5. The system of claim 1 wherein the gesture is one of: causing a hand of the avatar to hover on the indication of the vending item, causing a finger of the avatar to point to the indication of the vending item, causing a virtual physical object to be pushed or throw through the indication of the vending item, and causing the hand of the avatar to form a hand signal, the hand signal corresponding to the vending item.

6. The system of claim 1, wherein the operations further comprise:
generating a video of the user, wherein the video generated is based on the vending item; and
providing the user with a code for the user to access the video.

7. The system of claim 1, wherein the gesture is a first gesture, the vending item is a first vending item, and wherein the operations further comprise:
displaying indications of a plurality of vending times on the display, the plurality of vending items comprising clothing; and
in response to the user performing a second gesture, the second gesture indicating a second vending item, displaying on the display the avatar virtually wearing the second vending item.

8. The system of claim 7, wherein the operations further comprise:
providing a code to the user, the code indicating a website for the user to obtain the second vending item.

9. The system of claim 8, wherein the providing comprises:
sending the code to a mobile device of the user, sending the code to an email address of the user, or sending the code to a social media account of the user.

10. The system of claim 1, wherein the indication of the vending item is displayed to appear to three-dimensional to the user, and wherein the indication of the vending item is generated based on a location of the user relative to the display of the system, and wherein the operations further comprises:
adjusting the indication of the vending item based on the user moving to a new location.

11. The system of claim 1, wherein the system is a vending machine and wherein the dispensing the selected vending item comprises one of: displaying a code on the display, sending the code to a computing device associated with the user, dispensing a physical device from the vending machine, and printing the vending item on a printer of the system.

12. The system of claim 1 wherein the avatar is an image of the user, an avatar associated with the user, or an avatar selected by the system.

13. The system of claim 1, wherein the operations further comprise:
processing, based on an application selected by user or provided by the user, the image to generate a frame comprising the avatar and additional graphics.

14. The system of claim 1, wherein the processing the captured image further comprises:
determining a location of the user relative to the system; and
generating graphics of the vending item to appear three-dimensional (3D) based on the location of the user.

15. The system of claim 1, wherein the operations further comprise:
processing the image to generate the avatar and to generate augmented reality (AR) graphics of the vending item; and
sending, for display, the processed captured image to a wearable AR device of the user.

16. The system of claim 1, wherein the gesture is a first gesture and wherein the operations further comprise:
displaying on the display the avatar and indications of musical instruments;
in response to a second gesture to play a musical instrument of the musical instruments, generate and play on a speaker of the system music corresponding to the musical instrument;
recording the display and sounds from the speaker to generate a musical video; and
provide to the user a code to access the musical video.

17. A method comprising:
accessing a captured image;
processing the captured image to generate an avatar of a user;
presenting an image of the avatar with an indication of a vending item on a display of a system;
determining the user performed a gesture to select the vending item; and
dispensing the selected vending item.

18. The method of claim 17, wherein the method further comprises:
capturing the captured image using an image capturing device; and
processing the captured image to detect the user.

19. A non-transitory computer-readable storage medium storing instructions that, when executed by at least one processor of a computing device, cause the computing device to perform operations comprising:
accessing a captured image;
processing the captured image to generate an avatar of a user;
presenting an image of the avatar with an indication of a vending item on a display of a system;
determining the user performed a gesture to select the vending item; and
dispensing the selected vending item.

20. The non-transitory computer-readable storage medium of claim 19, wherein the operations further comprises:
capturing the captured image using an image capturing device; and
processing the captured image to detect the user.
